(19) United States
(12) Patent Application Publication
(10) Pub. No.: US 2009/0046554 A1
(43) Pub. Date: Feb. 19, 2009

(54) OPTICAL HEAD DEVICE AND OPTICAL INFORMATION RECORDING OR REPRODUCING APPARATUS EQUIPPED WITH SAME

(75) Inventor: Ryuichi Katayama, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/095,459

(22) PCT Filed: Nov. 16, 2006
(86) PCT No.: PCT/JP2006/322825

§ 371 Date: May 29, 2008

(30) Foreign Application Priority Data
Nov. 30, 2005 (JP) 2005-345928

(51) Int. Cl. G11B 7/135; G11B 20/18

(52) U.S. Cl. 369/53.28; 369/112.03; G9B/7.112; G9B/20.046

(57) ABSTRACT

[Problems] To provide an optical head device capable of obtaining a desirable track error signal and a lens position signal for both two types of optical media having different groove pitches.

[Means for Solving the Problems] Light emitted from a light source is divided by a diffraction optical element (3a) into a main beam that is transmitted light, first sub beams that are positive and negative first order diffracted light beams, and second sub beams that are positive and negative second order diffracted light beams. The phase of the positive and negative first order diffracted light beams from regions (13a, 13c) and that of the positive and negative first order diffracted light beams from regions (13b, 13d) are shifted from each other by 180 degrees, and the phase of positive and negative second order diffracted light beams from regions (13a, 13d) and that of the positive and negative second order diffracted light beams from regions (13b, 13c) are shifted from each other by 180 degrees. For a light recording medium having a narrow groove pitch, the difference between a main beam push-pull signal and a first sub beam push-pull signal is set as a track error signal. For a light recording medium having a wide groove pitch, the difference between a first sub beam push-pull signal and a second sub beam push-pull signal is set as a track error signal.

### TECHNICAL FIELD

The present invention relates to an optical head device and an optical information recording or reproducing apparatus for performing at least either recording or reproducing with respect to an optical recording medium having a groove, in particular, to an optical head device and an optical information recording or reproducing apparatus capable of obtaining an excellent tracking error signal and an excellent lens position signal with respect to any one of plural types of optical recording media having different groove pitches. “Recording or reproducing” mentioned in this case means at least either recording or reproducing, that is, both recording or reproducing, recording only, or reproducing only.

### BACKGROUND ART

Recordable and rewritable type optical recording media generally include a groove for tracking. In order to detect a tracking error signal with respect to those optical recording media, a push-pull method is normally used. However, an offset occurs on the tracking error signal according to the push-pull method when an objective lens of an optical head device shifts toward a radial direction of an optical recording medium. To prevent a recording and reproducing characteristic from degrading caused by the offset due to such a lens shift, the optical head devices and the optical information recording or reproducing apparatuses are required not to generate an offset due to the lens shifts on the tracking error signals.

Meanwhile, when an optical head device performs an operation of track-following for an optical recording medium, an objective lens of the optical head device normally follows a track on the optical recording medium in response to a tracking error signal, and an optical system except the objective lens in the optical head device follows the objective lens so that the objective lens is not out of a mechanically neutral position with respect to the optical system except the objective lens in the optical head device. Further, when the optical head device performs an operation of seeking for an optical recording medium, the objective lens is normally fixed at a mechanically neutral position with respect to the optical system except the objective lens in the optical head device, and the optical system except the objective lens in the optical head device moves toward a radial direction of the optical recording medium in response to a seek signal. In order to perform such a track-following operation and a seek operation stably, the optical head devices and the optical information recording or reproducing apparatuses are required to be capable of detecting a lens position signal which indicates a misalignment amount of the objective lens with respect to the mechanically neutral position.

Generally, viewing from a side of an incoming light, a concave part of a groove formed on the optical media is called as a LAND, and a convex part is called as a GROOVE. The optical recording media in a write-once type and a rewritable type include the optical recording media in a groove recording system for recording or reproducing only on the groove, such as a DVD-R (Digital Versatile Disc-Recordable), a DVD-RW (Digital Versatile Disc-Rewritable), and the like, and the optical recording media in a land-and-groove recording system for recording or reproducing on both the land and the groove, such as a DVD-RAM (Digital Versatile Disc-Random Access Memory), and the like. Normally, the optical recording media in the groove recording system has a narrower pitch of grooves than the optical recording media in the land-and-groove recording system. The optical head devices and the optical information recording or reproducing apparatuses are required to be capable of accepting those two types of optical recording media having different groove pitches.

Patent Documents 1-3 disclose the optical head devices which does not generate an offset due to the lens shift on a tracking error signal and which is capable of detecting a lens position signal, for both two types of the optical recording media having different groove pitches.

Optical head devices recited in Patent Documents 1 and 2 include a diffractive optical element. An emitting light beam from a semiconductor laser as a light source is split into five beams in total by the diffractive optical element, that is, a zeroth order light beam being a main beam, negative and positive first order diffracted light beams being first sub beams, and negative and positive second order diffracted light beams being second sub beams.

Each of FIGS. 17A and 17B shows an arrangement of focal spots on a disc that is an optical recording medium. FIG. 17A shows a disc in the groove recording system with a narrow pitch of grooves, and FIG. 17B shows a disc in the land-and-groove recording system with a wide pitch of grooves. The focal spots 36a, 36b, 36c, 36d, and 36e correspond to the zeroth order light beam, the positive first order diffracted light beams, the negative first order diffracted light beams, the positive second order diffracted light beams, and the negative second order diffracted light beams respectively from a diffractive optical element 34a. In FIG. 17A, the focal spot 36a is positioned on a track 20a that is a groove, the focal spot 36b is positioned almost on a land in an immediate right side of the track 20a, and the focal spot 36c is positioned almost on a land in an immediate left side of the track 20a. On the other hand, FIG. 17B shows a disc in the groove recording system with a wide pitch of grooves, where the focal spot 36a is positioned on a track 20b that is a land or a groove, the focal spot 36d is positioned almost on a groove or a land in an immediate right side of the track 20b, and the focal spot 36e is positioned almost on a groove or a land in an immediate left side of the track 20b.

As shown in FIG. 17A, when the disc is in the groove recording system with a narrow pitch of grooves, a difference between a main beam push-pull signal and a first sub beam push-pull signal is a tracking error signal, and a summation of a main beam push-pull signal and a first sub beam push-pull signal is a lens position signal. Meanwhile, as shown in FIG. 17B, when the disc is in the land-and-groove recording system with a wide pitch of grooves, a difference between a main beam push-pull signal and a second sub beam push-pull signal is a tracking error signal, and a summation of a main beam push-pull signal and a second sub beam push-pull signal is a lens position signal.

Another optical head device recited in Patent Document 1 includes diffractive optical elements 34b and 34c shown in FIGS. 18A and 18B. FIGS. 18A and 18B are plan views of the diffractive optical elements 34b and 34c respectively. The diffractive optical elements 34b and 34c include diffraction gratings formed on whole surfaces thereof which include effective diameters 34 of an objective lens indicated by dotted lines in the drawings. Directions of gratings in the diffraction gratings are slightly inclined with respect to a radial direction of a disc, and those inclinations in the diffractive optical elements 34b and 34c are different from each other. An emitting light beam from a semiconductor laser as a light source is split by the diffractive optical elements 34b and 34c into five beams in total, that is, a zeroth order light beam from the diffractive optical elements 34b and 34c being a main beam, positive and negative first order diffracted light beams from the diffractive optical element 34b, which are the zeroth order light beam from the diffractive optical element 34c, being first sub beams, and the zeroth order light beam from the diffractive optical element 34b, which is the positive and negative first order diffracted light beams from the diffractive optical element 34c, being second sub beams.

Another optical head device recited in Patent Document 2 includes a diffractive optical element 34d shown in FIG. 19. FIG. 19 is a plan view of the diffractive optical element 34d. The diffractive optical element 34d has a diffraction grating on a whole surface thereof including an effective diameter 34 of an objective lens indicated by dotted lines in the drawing, wherein the diffraction grating is divided into five areas 35a-35e by four lines symmetric with respect to an optical axis of an incoming light beam and parallel to a radial direction of a disc. Directions of the gratings of the diffraction gratings are slightly inclined with respect to the radial direction of the disc, and inclinations in the areas 35a-35c and in the areas 35d, 35e are different from each other. An emitting light beam from a semiconductor laser as a light source is split by the diffractive optical element 34d into five light beams in total, that is, a zeroth order light from the diffractive optical element 34d being a main beam, positive and negative first order diffracted lights from the areas 35d and 35e of the diffractive optical element 34d being first sub beams, and positive and negative first order diffracted lights from the areas 35a-35c of the diffractive optical element 34d being second sub beams.

Each of FIGS. 20A and 20B shows an arrangement of focal spots on a disc of the optical recording medium. FIG. 20A shows a disc in the groove recording system with a narrow pitch of grooves, and FIG. 20B shows a disc in the land-and-groove recording system with a wide pitch of grooves. In an optical head device including the diffractive optical elements 34b and 34c, focal spots 37a, 37b, 37c, 37d, and 37e correspond to the zeroth order light beam from the diffractive optical element 34b and 34c, the positive first order diffracted light from the diffractive optical element 34b that is the zeroth order light from the diffractive optical element 34c, the negative first order diffracted light from the diffractive optical element 34b that is the zeroth light beam from the diffractive optical element 34c, the zeroth order light beam from the diffractive optical element 34b that is the positive first order diffracted light from the diffractive optical element 34c, and the zeroth order light beam from the diffractive optical element 34b that is the negative first order diffracted light from the diffractive optical element 34c respectively. Further, in an optical head device including the diffractive optical element 34d, focal spots 37a, 37b, 37c, 37d, and 37e correspond to the zeroth order light beam from the diffractive optical element 34d, the positive first order diffracted light from the areas 35d and 35e of the diffractive optical element 34d, the negative first order diffracted light from the areas 35d and 35e of the diffractive optical element 34d, the positive first order diffracted light from the areas 35a-35c of the diffractive optical element 34d, and the negative first order diffracted light from the areas 35a-35c of the diffractive optical element 34d respectively.

In FIG. 20A, the focal spot 37a is arranged on the track 20a which is a groove, the focal spot 37b is arranged on a land in the right side of the track 20a next thereto, the focal spot 37c is arranged on a land in the left side of the track 20a next thereto respectively. Meanwhile, in FIG. 20B, the focal spot 37a is arranged on the track 20b which is a land or groove, the focal spot 37d is arranged on a groove or a land in the left side of the track 20b next thereto, and the focal spot 37e is arranged on a groove or a land in the right side of the track 20b next thereto respectively.

When the disc is in the groove recording system with a narrow pitch of grooves, a difference between a main beam push-pull signal and a first sub beam push-pull signal is a tracking error signal, and a summation of a main beam push-pull signal a first sub beam push-pull signal is a lens position signal. On the other hand, when the disc is in the land-and-groove recording system with a wide pitch of grooves, a difference between a main beam push-pull signal and a second sub beam push-pull signal is a tracking error signal, and a summation of a main beam push-pull signal and a second sub beam push-pull signal is a lens position signal.

An optical head device recited in Patent Document 3 includes a diffractive optical element. An emitting light beam from a semiconductor laser as a light source is split by the diffractive optical element into three light beams in total, that is, a zeroth order light beam being a main beam, and positive and negative first order diffracted light being sub beams.

Each of FIGS. 21A and 21B shows an arrangement of focal spots on a disc which is an optical recording medium. FIG. 21A shows a disc in the groove recording system with a narrow pitch of grooves, and FIG. 21B shows a disc in the land-and-groove recording system with a wide pitch of grooves. Focal spots 38a, 38b, 38c correspond to the zeroth order light beam, the positive first order diffracted light, and the negative first order diffracted light from the diffractive optical element 34e respectively. In FIG. 21A, the focal spot 38a is arranged on the track 20a which is a groove, the focal spot 38b is arranged on a land in the right side of the track 20a and an interval in between them is almost 2.5 times of pitch, the focal spot 38c is arranged on a land in the left side of the track 20a and an interval in between them is almost 2.5 times of pitch, respectively. On the other hand, in FIG. 21B, the focal spot 38a is arranged on the track 20b which is a land or a groove, the focal spot 38b is arranged on a groove or a land in the right side of the track 20b and an interval in between them is almost 1.5 times of pitch, and the focal spot 38c is arranged on a groove or a land in the left side of the track 20b and an interval in between them is almost 1.5 times of pitch, respectively.

Both in the case with the disc in the groove recording system with a narrow pitch of grooves and the disc in the land-and-groove recording system with a wide pitch of grooves, a difference between a main beam push-pull signal and a sub beam push-pull signal is a tracking error signal, and a summation of a main beam push-pull signal and a sub beam push-pull signal is a lens position signal.

Patent Document 1: Japanese Patent Application Laid-open No. 10-83546

### Patent Document 2: Japanese Patent Application Laid-open No. 2004-5859

### Patent Document 3: Japanese Patent Application Laid-open No. 2004-39063

### DISCLOSURE OF THE INVENTION

### Problems to be Solved by the Invention

According to the aforementioned optical head device including the diffractive optical elements 34a-34d, in the case with the disc in the groove recording system with a narrow pitch of grooves, the focal spot of the first sub beam is positioned in an interval of half groove pitches from the focal spot of the main beam. The discs in the groove recording system such as the DVD-R, the DVD-RW, and the like have a standard with two layers. Next, an offset on a tracking error signal is considered in a case with a disc having two layers in continuous recording.

Each of FIGS. 22A and 22B shows an arrangement of focal spots on a disc with two layers. A focal spot 40a is a focal spot of the main beam, and is arranged on a track 39a of a groove. Further, focal spots 40b and 40c are focal spots of the first sub beam, and are arranged on a land in between tracks 39a and 39c and on a land in between tracks 39a and 39b, respectively. The right side and the left side in the drawings correspond to an inner circumference side and an outer circumference side of the disc respectively, and the focal spots 40a-40c go ahead toward an upper side from a bottom side. Normally in the discs with two layers, recording is performed from the inner circumference side toward the outer circumference side on a first layer, and then from the outer circumference side toward the inner circumference side on a second layer. Therefore, in the continuous recording on the first layer, the whole track 39b and a portion of the track 39a under the focal spot 40a, which are indicated in gray in FIG. 22A, are to be a recorded section. In the continuous recording on the second layer, the whole track 39c and a portion of the track 39a under the focal spot 40a, which are indicated in gray in FIG. 22B, are to be a recorded section.

In FIG. 22A, both of the track 39a in the immediate left side of the land on which the focal spot 40b is positioned and the track 39c in the immediate right side of the land on which the focal spot 40b are unrecorded sections. Both of the track 39b in the immediate left side of the land on which the focal spot 40c is positioned and the track 39a in the immediate right side of the land on which the focal spot 40c is positioned are recorded sections. Therefore, a distribution of reflectance on the disc is bilaterally symmetric at the focal spots 40b and 40c, and an offset does not occur on a first sub beam push-pull signal. On the other hand, in FIG. 22B, the track 39a in the immediate left side of the land on which the focal spot 40b is positioned is an unrecorded section, the track 39c in the immediate right side of the land on which the focal spot 40b is positioned is a recorded section, the track 39b in the immediate left side of the land on which the focal spot 40c is positioned is an unrecorded section, and the track 39a in the immediate right side of the land on which the focal spot 40c is positioned is a recorded section. Therefore, the distribution of reflectance on the disc is bilaterally asymmetric at the focal spots 40b and 40c, and an offset occurs on a first sub beam push-pull signal. Consequently, an offset does not occur on a tracking error signal during the continuous recording on the first layer, but an offset occurs on a tracking error signal during the continuous recording on the second layer.

According to the optical head device including the diffractive optical element 34e, in the case with the disc in the groove recording system with a narrow pitch of grooves, the focal spots of the sub beams are positioned with an interval of 2.5 times of groove pitch from the focal spot of the main beam. In the case with the disc in the land-and-groove recording system with a wide pitch of grooves, the focal spots of the sub beams are positioned with intervals of 1.5 times of groove pitches from the focal spot of the main beam. In this case, when a wavelength of the semiconductor laser of the light source is varied according to a variation of temperature, diffraction angles of the positive and negative first order diffracted lights at the diffractive optical element 34e are varied, and intervals between the focal spots 38a-38c on the disc shown in FIGS. 21A and 21B are changed. Then, an amount of the interval between the focal spots of the sub beams and the focal spot of the main beam in the radial direction of the disc is shifted from 2.5 times of groove pitches or 1.5 times of groove pitches. In this optical head device, angles between a line connecting the focal spots 38a-38c and the tracks 20a, 20b are wide. Therefore, when the intervals between the focal spots 38a-38c are varied, the amount of interval between the focal spots of the sub beams and the focal spot of the main beam changes much. Consequently, amplitude of a sub beam push-pull signal changes much due to an eccentricity of the disc, so that amplitude of a tracking error signal also changes much.

Therefore, an object of the present invention is to provide an optical head device and an optical information recording or reproducing apparatus capable of obtaining an excellent tracking error signal and an excellent lens position signal with respect to two types of optical recording media having different pitches of grooves, wherein an offset due to lens shift does not occur on the tracking error signal, aforementioned problems in the traditional optical head devices capable of detecting a lens position signal can be solved, an offset on a tracking error signal does not occur during continuous recording on a disc with two layers, and amplitude of a tracking error signal is not varied much even with an eccentricity of the disc.

### Means for Solving the Problems

An optical head device according to the present invention uses at least a first optical recording medium in a disk-shape having a first pitch of grooves composing a track and a second optical recording medium in a disk-shape having a second pitch of grooves composing a track, as an optical recording medium, and includes: a light source; an objective lens for collecting an emitting light beam from the light source on the optical recording medium; a diffractive optical element disposed in between the light source and the objective lens; and a photodetector for receiving a reflected light beam from the optical recording medium; wherein the diffractive optical element generates at least a main beam, a first sub beam group, and a second sub beam group, which are collected on a same track on the optical recording medium and have different phase distributions from each other, from the emitting light beam of the light source by the objective lens, a light receiving section of the photodetector includes a first light receiving section group for receiving a reflected light beam of the main beam reflected by the optical recording medium to detect a push-pull signal with respect to at least the first and the second optical recording media, a second light receiving section group for receiving a reflected light of the first sub beam group reflected by the optical recording medium to detect a push-pull signal with respect to at least the first optical recording medium, and a third light receiving section group for receiving a reflected light of the second sub beam group reflected by the optical recording medium to detect a push-pull signal with respect to at least the second optical recording medium.

Further, an optical information recording or reproducing apparatus according to the present invention includes: the aforementioned optical head device according to the present invention; a detecting unit for detecting a push-pull signal with respect to at least the first and the second optical recording media from an output of the first light receiving section group; a detecting unit for detecting a push-pull signal with respect to at least the first optical recording medium from the second light receiving section group; a detecting unit for detecting a push-pull signal with respect to at least the second optical recording medium from an output of the third light receiving section group; and

a detecting unit for detecting a tracking error signal from a difference between a push-pull signal detected from an output of the first light receiving section group and a push-pull signal detected from an output of the second light receiving section group when the optical recording medium is the first optical recording medium, and detecting a tracking error signal from a difference between a push-pull signal detected from an output of the first light receiving section group and a push-pull signal detected from an output of the third light receiving section when the optical recording medium is the second optical recording medium.

Alternatively, an optical head device according to the present invention uses at least a first optical recording medium in a disk-shape having a first pitch of grooves composing a track and a second optical recording medium in a disk-shape having a second pitch of grooves composing a track, as an optical recording medium, and includes: a light source; an objective lens for collecting an emitting light beam from the light source on the optical recording medium; a diffractive optical element disposed in between the light source and the objective lens; and a photodetector for receiving a reflected light beam from the optical recording medium; wherein the diffractive optical element generates at least a main beam and a sub beam group, which are collected on a same track of the optical recording medium by the objective lens and have different phase distributions from each other, from the emitting light beam of the light source, a light receiving section of the photodetector includes a first light receiving section group for receiving a reflected light of the main beam reflected by the optical recording medium to detect a push-pull signal with respect to at least the first and the second optical recording media, and a second light receiving section group for receiving a reflected light beam of the sub beam group reflected by the optical recording medium to detect a push-pull signal with respect to at least the first and the second optical recording media, and the light receiving section further includes a phase distribution variation unit for varying a phase distribution of the sub beam group between a first phase distribution and a second phase distribution, working with the diffractive optical element.

Further, an optical information recording or reproducing apparatus according to the present invention includes: the aforementioned optical head device according to the present invention; a detecting unit for detecting a push-pull signal with respect to at least the first and the second optical recording media from an output of the first light receiving section; a detecting unit for detecting a push-pull signal with respect to at least the first and the second optical recording media from an output of the second light receiving section group; and a detecting unit for detecting a tracking error signal from a difference between a push-pull signal detected from an output of the first light receiving section group and a push-pull signal detected from an output of the second light receiving section group when the phase distribution variation unit varies a phase distribution of the sub beam group into a first phase distribution in a case where the optical recording medium is the first optical recording medium, and for detecting a tracking error signal from a difference between a push-pull signal detected by an output of the first light receiving section group and a push-pull signal detected from an output of the second light receiving section group when the phase distribution variation unit varies a phase distribution of the sub beam group into a second phase distribution in a case where the optical recording medium is the second optical recording medium.

In the optical head device and the optical information recording or reproducing apparatus according to the present invention, the main beam, the first sub beam group, and the second sub beam group are collected on a same track of an optical recording medium. For the first optical recording medium, push-pull signals are detected from an output of the first light receiving section group for receiving a reflected light beam of the main beam reflected by the optical recording medium and an output of the second light receiving section group for receiving a reflected light beam of the first sub beam group reflected by the optical recording medium respectively, and then a tracking error signal is detected from a difference of those push-pull signals. On the other hand, for the second optical recording medium, push-pull signals are detected from an output of the first light receiving section group for receiving a reflected light beam of the main beam reflected by the optical recording medium and an output of the third light receiving section group for receiving a reflected light beam of the second sub beam group reflected by the optical recording medium, and a tracking error signal is detected from a difference of those push-pull signal. A phase distribution of the first sub beam group can be set so that a push-pull signal by the first sub beam group and a push-pull signal by the main beam have opposite polarity to each other with respect to the first optical recording medium. A phase distribution of the second sub beam group can be set so that a push-pull signal by the second sub beam group and a push-pull signal by the main beam have opposite polarity to each other with respect to the second optical recording medium.

Alternatively, in the optical head device and the optical information recording or reproducing apparatus according to the present invention, the main beam and the sub beam group are collected on a same track of an optical recording medium. For the first optical recording medium, a phase distribution of the sub beam group is set to be a first phase distribution, and push-pull signals are detected respectively from an output of the first light receiving section group for receiving a reflected light beam of the main beam reflected by the optical recording medium and an output of the second light receiving section group for receiving a reflected light beam of the sub beam group reflected by the optical recording medium, and a tracking error signal is detected from a difference of those push-pull signals. On the other hand, for the second optical recording medium, a phase distribution of the sub beam group is set to be a second phase distribution, and push-pull signals are detected respectively from an output of the first light receiving section group for receiving a reflected light beam of the main beam reflected by the optical recording medium and an output of the second light receiving section group for receiving a reflected light beam of the sub beam group reflected by the optical recording medium, and a tracking error signal is detected from a difference of those push-pull signals. The first phase distribution can be set so that a push-pull signal by the sub beam group and a push-pull signal by the main beam have opposite polarity to each other with respect to the first optical recording medium, and a second phase distribution can be set so that a push-pull signal by the sub beam group and a push-pull signal by the main beam have opposite polarity to each other with respect to the second optical recording medium.

Next, an operation of the present invention will be explained. In a disc with two layers, a focal spot of the main beam and the focal spots of the sub beam group are arranged on the same track of a groove, and both lands in the immediate right and left side of the track having the focal spots of the sub beam group are unrecorded sections. Therefore, a distribution of reflectance in the disc at the focal spots of the sub beam group becomes bilaterally symmetric, and an offset does not occur on a push-pull signal by the sub beams group. Consequently, an offset does not also occur on a tracking error signal during continuous recording on the disc with two layers.

Further, the focal spot of the main beam and the focal spots of the sub beam group are arranged on the same track. Therefore, even if intervals between the focal spot of the main beam and the focal spots of the sub beam group are varied, the amount of interval between the focal spot of the main beam and the focal spots of the sub beam group with respect to the radial direction of the disc is zero. Consequently, amplitude of a sub beam push-pull signal does not vary much even with an eccentricity of the disc, and amplitude of a tracking error signal is not varied much, too.

### ADVANTAGEOUS EFFECT OF THE INVENTION

As described above, according to the optical head device and the optical information recording or reproducing apparatus in the present invention, an excellent tracking error signal and an excellent lens position signal can be obtained with respect to two types of optical recording media having different pitches of grooves while an offset does not occur on the tracking error signal during continuous recording on a disc with two layers, and while amplitude of the tracking error signal does not vary much even with an eccentricity of the disc. A reason for the above is that the main beam and the sub beam group having different phase distributions with each other are collected on a same track of an optical recording medium. For example, the reason is that the main beam and the sub beam group are collected on the same track of the optical recording medium, and a phase distribution of the sub beam group is set so that a push-pull signal thereof has opposite polarity to a push-pull signal of the main beam with respect to each two types of the optical recording media.

### BEST MODES FOR CARRYING OUT THE INVENTION

Hereinafter, exemplary embodiments of the invention will be explained with reference to the drawings. FIG. 1 shows a first exemplary embodiment of an optical head device according to the invention. An emitting light beam from a semiconductor laser 1 is collimated by a collimator lens 2, and is split by a diffractive optical element 3a into five beams in total, that is, a zeroth order light beam being a main beam, positive and negative first order diffracted light beams being first sub beams, and positive and negative second order diffracted light beams being second sub beams. Those light beams inject into a polarization beam splitter 4 as P polarizations to be transmitted by almost 100%, and then they are transmitted by a quarter wavelength plate 5 to be converted from linear polarizations into circular polarizations, and collected on a disc 7 by an objective lens 6. Five reflected light beams from the disc 7 are transmitted by the objective lens 6 inversely, and are transmitted the quarter wavelength plate 5 to be converted from the circular polarizations into linear polarizations having a polarization direction orthogonal to the linear polarizations of an incoming way, and inject into the polarization beam splitter 4 as S polarizations to be reflected by almost 100%, and then they are transmitted by a cylindrical lens 8, a convex lens 9 to be received by a photodetector 10a. The photodetector 10a is disposed in a middle of two focal lines of the cylindrical lens 8 and the convex lens 9.

FIG. 2 is a plan view of the diffractive optical element 3a. The diffractive optical element 3a has a diffraction grating formed on a whole surface thereof including an effective diameter 6a of the objective lens 6 indicated by dotted lines in the drawing, wherein the diffraction grating is divided into four areas 13a-13d by three lines symmetric with respect to an optical axis of an incoming light and parallel to a tangential direction of the disc 7. Each grating direction in the diffraction grating is parallel to a radial direction of the disc 7 respectively, and each pattern of gratings is linear having even pitch. Pitches of gratings in areas 13a-13d are even.

In this case, assuming that a wavelength of the semiconductor laser 1 is λ, a numerical aperture of the objective lens 6 is NA, and a pitch of grooves is Tp2 when the disc 7 is in the land-and-groove recording system with a wide pitch of grooves, then ratios of widths of the areas 13a and 13b with respect to the effective diameter 6a of the objective lens 6 are λ/(2·NA·Tp2) respectively. For example, an incoming light beam of the diffractive optical element 3a is transmitted by about 80.0% to be the zeroth order light beam, diffracted by about 3.2% each to be the positive and negative first order diffracted light beams, and diffracted by about 3.0% each to be the positive and negative second order diffracted light beams. A phase shift between the positive and negative first order diffracted light beams from the areas 13a and 13c and the positive and negative first order diffracted light beams from the areas 13b and 13d is 180 degrees, and a phase shift between the positive and negative second order diffracted light beams from the areas 13a and 13d and the positive and negative second order diffracted light beams from the areas 13b and 13c is 180 degrees. Consequently, the main beam, the first sub beams, and the second sub beams have different phase distributions from each other.

Each of FIGS. 3A and 3B shows an arrangement of focal spots on the disc 7. FIG. 3A shows a case where the disc 7 is in the groove recording system with a narrow pitch of grooves, and FIG. 3B shows a case where the disc 7 is in the land-and-groove recording system with a wide pitch of grooves. Focal spots 21a, 21b, 21c, 21d, and 21e correspond to the zeroth order light beam, the positive first order diffracted light, the negative first order diffracted light, the positive second order diffracted light, and the negative second order diffracted light from the diffractive optical element 3a, respectively. In FIG. 3A, the focal spots 21a-21e are arranged on a same track 20a of a groove. In FIG. 3B, the focal spots 21a-21e are arranged on a same track 20b of a land or a groove. The focal spots 21b and 21c of the first sub beams and the focal spots 21d and 21e of the second sub beams have two peaks with same intensities in a right and left side of the radial direction of the disc 7.

FIG. 4 shows a pattern of the light receiving sections of the photodetector 10a and an arrangement of optical spots on the photodetector 10a. An optical spot 24a corresponds to the zeroth order light beam from the diffractive optical element 3a, and it is received by four of light receiving sections 23a-23d into which a light receiving section is divided by dividing lines passing through an optical axis, one of the dividing line is parallel to a tangential direction of the disc 7 and the other one of the dividing lines is parallel to the radial direction of the disc 7. An optical spot 24b corresponds to the positive first order diffracted light beam from the diffractive optical element 3a, and it is received by two of light receiving sections 23e and 23f into which a light receiving section is divided by a dividing line passing through an optical axis and parallel to the radial direction of disc 7. An optical spot 24c corresponds to the negative first order diffracted light beam from the diffractive optical element 3a, and it is received by two of light receiving sections 23g and 23h into which a light receiving section is divided by a dividing line passing through an optical axis and parallel to the radial direction of the disc 7. An optical spot 24d corresponds to the positive second order diffracted light beam from the diffractive optical element 3a, and it is received by two of light receiving sections 23i and 23j into which a light receiving section is divided by a dividing line passing through an optical axis and in parallel to the radial direction of the disc 7. An optical spot 24e corresponds to the negative second order diffracted light from the diffractive optical element 3a, and it is received by two of light receiving sections 23k and 23l into which a light receiving section is divided by a dividing line passing through an optical axis and parallel to the radial direction of the disc 7. As for the optical spots 24a-24e, intensity distributions in the tangential direction and intensity distributions in the radial direction in the disc 7 are exchanged with each other according to effects of the cylindrical lens 8 and the convex lens 9.

When outputs from the light receiving sections 23a-23l are expressed by V23a−V23l, a focus error signal can be obtained by an equation of (V23a+V23d)−(V23b+V23c) by using an astigmatic method. A main beam push-pull signal can be given by (V23a+V23b)−(V23c+V23d), a first sub beam push-pull signal can be given by (V23e+V23g)−(V23f+V23h), a second sub beam push-pull signal can be given by (V23i+V23k)−(V23j+V23l), respectively. A difference between the main beam push-pull signal and the first or the second sub beam push-pull signal is a tracking error signal, and a summation of the main beam push-pull signal and the first or the second sub beam push-pull signal is a lens position signal. An RF signal recorded on the disc 7 can be obtained by an equation, (V23a+V23b+V23c+V23d).

FIGS. 5A-5D show various push-pull signals relating to detection of the tracking error signal and the lens position signal. Horizontal axes in the drawing show detracking amounts of the optical spots, vertical axes show push-pull signals. When the objective lens 6 shifts toward the radial direction of the disc 7, an offset occurs on a push-pull signal due to the lens shift. Push-pull signals 27a and 27b shown in FIG. 5A are a main beam push-pull signal and a first or a second sub beam push-pull signal respectively in a case where the objective lens 6 shifts toward an outer side of the radial direction of the disc 7. Further, push-pull signals 27c and 27d shown in FIG. 5B are a main beam push-pull signal and a first or a second sub beam push-pull signal respectively in a case where the objective lens 6 shifts toward an inner side of the radial direction of the disc 7. The main beam push-pull signals and the first or the second sub beam push-pull signals have opposite polarities with each other, but offsets are in a same sign when the objective lens 6 shifts toward the radial direction of the disc 7. Therefore, the offsets are positive in FIG. 5A, and negative in FIG. 5B.

Meanwhile, a push-pull signal 27e shown in FIG. 5C is a tracking error signal which is a difference between a main beam push-pull signal and a first or a second sub beam push-pull signal in a case where the objective lens 6 shifts toward the outer side and the inner side of the radial direction of the disc 7. In FIG. 5C, the offsets of the push-pull signal in FIGS. 5A and 5B are cancelled with each other, so that an offset due to the lens shift does not occur on the tracking error signals. Further, push-pull signals 27f and 27g shown in FIG. 5D are lens position signals, which are summations of the main beam push-pull signal and the first or the second sub beam push-pull signal, in a case where the objective lens 6 shifts toward the outer side or the inner side of the radial direction of disc 7, respectively. In FIG. 5D, groove crossing components of the push-pull signals in FIGS. 5A and 5B are cancelled with each other, so that a groove crossing noise does not occurs on the lens position signals.

FIG. 6A shows a phase distribution of the first sub beam reflected by the disc 7 and the first sub beam diffracted by the disc 7 in a case where the disc 7 is in the groove recording system with a narrow pitch of grooves. In this case, a focal spot of the first sub beam is positioned at a center of a track on the disc 7. An area 28a corresponds to the positive and negative first order diffracted light beams from the areas 13a and 13c of the diffractive optical element 3a, out of light beams reflected as the zeroth order light beam by the disc 7. An area 28b corresponds to the positive and negative first order diffracted light beams from the areas 13b and 13d of the diffractive optical element 3a, out of light beams reflected as the zeroth order light beam by the disc 7. An area 28c corresponds to the positive and negative first order diffracted light beam from the areas 13a and 13c of the diffractive optical element 3a, out of light beams diffracted as the positive first order diffracted light beam by the disc 7. An area 28d corresponds to the positive and negative first order diffracted light beams from the areas 13b and 13d of the diffractive optical element 3a, out of light beams diffracted as the positive first order diffracted light beam by the disc 7. An area 28e corresponds to the positive and negative first order diffracted light beams from the areas 13a and 13c of the diffractive optical element 3a, out of light beams diffracted as the negative first order diffracted light beam by the disc 7. An area 28f corresponds to the positive and negative first order diffracted light beams from the areas 13b and 13d of the diffractive optical element 3a, out of light beams diffracted as the negative first order diffracted light beam by the disc 7. Optical phases of the areas in which + or − is written in the drawing are +90° and −90° respectively.

A light beam reflected by the disc 7 and a light beam diffracted by the disc 7 interfere with each other at a crossover of both light beams, and a push-pull signal is detected by using a variation of interfering light intensities depending on each phase. In FIG. 6A, the area 28a of the zeroth order light beam and the area 28b of the positive first order diffracted light beam are overlapped, and the area 28b of the zeroth order light beam and the area 28e of the negative first order diffracted light beam are overlapped. Optical phases shift by 180 degrees between the areas 28a and 28d, and optical phases also shift by 180 degrees between the areas 28b and 28e. Then, a polarity of a first sub beam push-pull signal inverts with respect to a main beam push-pull signal.

FIG. 6B shows a phase distribution of the second sub beam reflected by the disc 7 and the second sub beam diffracted by the disc 7 in a case where the disc 7 is in the land-and-groove recording system with a wide pitch of grooves. In this case, focal spots of the second sub beam are positioned at a center of a track on the disc 7. Areas 29a, 29b, 29c, and 29d correspond to the positive and negative first order diffracted light beams from the areas 13a, 13b, 13c, and 13d of the diffractive optical element 3a, respectively, out of light beams reflected as the zeroth order light beam by the disc 7. Areas 29e, 29f, 29g, and 29h correspond to the positive and negative first order diffracted light beams from the areas 13a, 13b, 13c, and 13d of the diffractive optical element 3a, respectively, out of light beams diffracted as the positive first order diffracted light beam by the disc 7. Areas 29i, 29j, 29k, and 29l correspond to the positive and negative first order diffracted light beams from the areas 13a, 13b, 13c, and 13d of the diffractive optical element 3a, respectively, out of light beams diffracted as the negative first order diffracted light beam by the disc 7. Optical phases of the areas in which + and − are written in the drawing are +90°, −90° respectively.

The light beam reflected by the disc 7 and the light beam diffracted by the disc 7 interfere with each other at a crossover of both light beams, and a push-pull signal is detected by using a variation of interfering light intensities depending on each phase. In FIG. 6B, the areas 29c, 29a, 29b of the zeroth light beam and the areas 29e, 29f, 29h of the positive first order diffracted light beam are overlapped respectively, and the areas 29d, 29b, 29a of the zeroth order light beam and areas 29j, 29i, 29k of the negative first order diffracted light beam are overlapped respectively. Optical phases shift by 180 degrees between the areas 29c, 29a, 29b and the areas 29e, 29f, 29h. Optical phases shift by 180 degrees between the areas 29d, 29b, 29a and the areas 29j, 29i, 29k. Then, a polarity of a second sub beam push-pull signal is inverted with respect to a main beam push-pull signal.

In the exemplary embodiment, when the disc 7 is in the groove recording system with a narrow pitch of grooves, a difference between a main beam push-pull signal and a first sub beam push-pull signal is a tracking error signal, and a summation of a main beam push-pull signal and a first sub beam push-pull signal is a lens position signal. Further, when the disc 7 is in the land-and-groove recording system with a wide pitch of grooves, a difference between a main beam push-pull signal and a second sub beam push-pull signal is a tracking error signal, and a summation of a main beam push-pull signal and a second sub beam push-pull signal a lens position signal.

In this case, a phase distribution of the first sub beams is set so that a first sub beam push-pull signal and a main beam push-pull signal have opposite polarities to each other when the disc 7 is in the groove recording system with a narrow pitch of grooves. Further, a phase distribution of the second sub beams is set so that a second sub beam push-pull signal and a main beam push-pull signal have opposite polarities to each other when the disc 7 is in the land-and-groove recording system with a wide pitch of grooves. Accordingly, an offset due to the lens shift does not occur on a tracking error signal with respect to two types of discs having different groove pitches, in addition, a groove crossing noise does not occur on a lens position signal. Further, one focal spot of the main beam, two focal spots of the first sub beam, and two focal spots of the second sub beam are arranged on a same track of the disc 7. Accordingly, an offset does not occur on a tracking error signal during continuous recording on a disc with two layers. Therefore, amplitude of a tracking error signal is not varied much even with an eccentricity of the disc.

FIGS. 7A-7D are cross-sectional views of the diffractive optical element 3a. The diffractive optical element 3a includes a substrate 15 having a dielectric body 16 formed thereon. A cross-sectional shape of the dielectric body 16 is shown as follows: that is, a repetition of a line section with a width of P/2-A, a space section with a width of A, a line section with a width of A, and a space section with a width of P/2-A in FIG. 7A; a repetition of a space section with a width of P/2-A, a line section with a width of A, a space section with a width of A, and a line section with a width of P/2-A in FIG. 7B; a repetition of a space section with a width of A, a line section with a width of P/2-A, a space section with a width of P/2-A, and a line section with a width of A in FIG. 7C; and a line section with a width of A, a space section with a width of P/2-A, a line section with a width of P/2-A, and a space section with a width of A in FIG. 7D. That is, each interval of grating is P. A difference between heights between the line sections and the space sections is H1.

In this case, assuming that a wavelength of the semiconductor laser 1 is λ, a refraction index of the dielectric body 16 is n, and a transmissivity of the diffractive optical element 3a, a diffraction efficiency of positive and negative first order, a diffraction efficiency of positive and negative second order are η0, η1, η2, respectively, following equations (1)-(4) are satisfied;

η0=cos²(φ/2) (1)

η1=(2/π)² sin²(φ/2)sin²[π(1−4A/P)/2] (2)

η2=(1/π)² sin²(φp/2){1+cos [π(1−4A/P)]}² (3)

φ=4π(n−1)H1/λ (4)

For example, assuming that φ=0.295π, A=0.142 P, then η0=0.800, η1=0.0032, η2=0.030. That is, about 80% of an incoming light beam into the diffractive optical element 3a is transmitted to be the zeroth order light beam, about 3.2% each of that is diffracted to be the positive and negative first order diffracted light beams, and about 3.0% each of that is diffracted to be the positive and negative second order diffracted light beams.

When the dielectric bodies 16 in the areas 13a, 13b, 13c, and 13d of the diffractive optical element 3a are set in shapes shown in FIGS. 7A, 7B, 7C, 7D respectively, phases of the positive and negative first order diffracted light beams from the areas 13a, 13c and the positive and negative first order diffracted light beams from the areas 13b, 13d are shifted by 180 degrees from each other, and phases of the positive and negative second order diffracted light beams from the areas 13a, 13d and the positive and negative second order diffracted light beams from areas 13b and 13c are shifted by 180 degrees from each other.

In a second exemplary embodiment of an optical head device according to the invention, the diffractive optical element 3a in the first exemplary embodiment is replaced with a diffractive optical element 3b shown in FIG. 8.

FIG. 8 is a plan view of the diffractive optical element 3b. The diffractive optical element 3b has a diffraction grating formed on a whole surface thereof including an effective diameter 6a of the objective lens 6 indicated by dotted lines in the drawing, wherein the diffraction grating is divided into five areas 13e-13i by four lines symmetric with respect to an optical axis of an incoming light beam and parallel to the tangential direction of the disc 7. Each grating direction in the diffraction grating is parallel to the radial direction of the disc 7, each grating pattern is linear with even pitch. Grating pitches over the areas 13e-3i are even.

In this case, assuming that a wavelength of the semiconductor laser 1 is λ, a numerical aperture of the objective lens 6 is NA, a groove pitch is Tp1 when the disc 7 is in the groove recording system with a narrow pitch of grooves, a groove pitch is Tp2 when the disc 7 is in the land-and-groove recording system with a wide pitch of grooves, then a ratio of a width of the area 13e with respect to the effective diameter 6a of the objective lens 6 and a ratio of a total width of the areas 13e-13g are λ/(2·NA·Tp2) and λ/(2·NA·Tp1) respectively. For example, an incoming light beam into the diffractive optical element 3b is transmitted by about 80.0% to be the zeroth order light beam, diffracted by about 3.2% each to be the positive and negative first order diffracted light beams, and diffracted by about 3.0% each to be the positive and negative second order diffracted light beams. Phases are shifted by 180 degrees between the positive and negative first order diffracted light beams from the areas 13e, 13f, 13g and the positive and negative first order diffracted light beams from the areas 13h, 13i. Phases are shifted by 180 degrees between the positive and negative second order diffracted light beams from the area 13e and the positive and negative second order diffracted light beams from the areas 13f, 13g, 13h, and 13i. Consequently, the main beam, the first sub beams, and the second sub beams have different phase distributions from each other.

An arrangement of focal spots on the disc 7 according to the exemplary embodiment is the same as in FIGS. 3A and 3B. In the exemplary embodiment, as in the same manner with the first exemplary embodiment, one focal spot of the main beam, two focal spots of the first sub beam, and two focal spots of the second sub beam are arranged on a same track of the disc 7 respectively.

A pattern of the light receiving sections of the photodetector 10a and an arrangement of optical spots on the photodetector 10a according to the present invention is the same as in FIG. 4. In the exemplary embodiment, as in the same manner with the first exemplary embodiment, a focus error signal, a main beam push-pull signal, a first sub beam push-pull signal, a second sub beam push-pull signal, an RF signal recorded on the disc 7 can be obtained. A difference between the main beam push-pull signal and the first or the second sub beam push-pull signal is a tracking error signal, and a summation of the main beam push-pull signal and the first or the second sub beam push-pull signal is a lens position signal.

various push-pull signals relating to detection of the tracking error signal and the lens position signal according to the exemplary embodiment are the same as in FIGS. 5A-5D. In the exemplary embodiment, as in the same manner with the first exemplary embodiment, an offset due to lens shift does not occur on the tracking error signal, and a groove crossing noise does not occur in the lens position signal.

FIG. 9A shows a phase distribution of the first sub beams reflected by the disc 7 and the first sub beams diffracted by the disc 7 when the disc 7 is in the groove recording system in a narrow pitch of grooves. Note that the focal spots of the first sub beam are positioned at a center on a track of the disc 7 in this case. Areas 30a/30b, 30c correspond to the positive and negative first order diffracted light beams from the areas 13e-13g, 13h, and 13i of the diffractive optical element 3b respectively, out of light beams reflected as the zeroth order light beam by the disc 7. Areas 30d, 30e, 30f correspond to the positive and negative first order diffracted light beams from the areas 13e-13g, 13h, and 13i of the diffractive optical element 3b respectively, out of light beams diffracted as the positive first order diffracted light beam by the disc 7. Areas 30g, 30h, 30i correspond to the positive and negative first order diffracted light beams from the areas 13e-13g, 13h, and 13i of the diffractive optical element 3b respectively, out of light beams diffracted as the negative first order diffracted light beam by the disc 7. Optical phases of the areas in which + and − are written in the drawing are +90°, −90° respectively.

A light beam reflected by the disc 7 and a light beam diffracted by the disc 7 interfere with each other at a crossover of both light beams, and a push-pull signal is detected by using variation of interfering light intensities depending on each phase. In FIG. 9A, the areas 30b and 30a of the zeroth order light beam and the areas 30d and 30f of the positive first order diffracted light beam are overlapped, and the areas 30c and 30a of the zeroth order light beam and the areas 30g and 30h of the negative first order diffracted light beam are overlapped. Optical phases are shifted by 180 degrees between the areas 30b, 30a and the areas 30d, 30f, and optical phases are shifted by 180 degrees between the areas 30c, 30a and the areas 30g, 30h. At this time, a polarity of a first sub beam push-pull signal is inverted with respect to a main beam push-pull signal.

FIG. 9B shows a phase distribution of the second sub beams reflected by the disc 7 and the second sub beams diffracted by the disc 7 when the disc 7 is in the land-and-groove recording system with a wide pitch of grooves. Note that the focal spots of the second sub beam are positioned at a center on a track of the disc 7 in this case. Areas 31a, 31b, 31c correspond to the positive and negative first order diffracted light beams from the areas 13e, 13f, 13h, 13g, 13i of the diffractive optical element 3b respectively, out of light beams reflected as the zeroth order light beam by the disc 7. Areas 13d, 13e, 13f correspond to the positive and negative first order diffracted light beams from the areas 13e, 13f, 13h, 13g, 13i of the diffractive optical element 3b respectively, out of light beams diffracted as the positive first order diffracted light beam by the disc 7. Areas 31g, 31h, 31i correspond to the positive and negative first order diffracted light beams from the areas 13e, 13f, 13h, 13g, 13i of the diffractive optical element 3b respectively, out of light beams of diffracted as the negative first order diffracted light beam by the disc 7. Optical phases of the areas in which + and − are written in the drawing are +90° and −90° respectively.

A light beam reflected by the disc 7 and a light beam diffracted by the disc 7 interfere with each other at a crossover of both light beams, and a push-pull signal is detected by using variation of interfering light intensities depending on each phase. In FIG. 9B, the areas 31b, 31a of the zeroth order light beam and the areas 31d, 31f of the positive first order diffracted light beam are overlapped, and the areas 31c, 31a of the zeroth order light beam and the areas 31g, 31h of the negative first order diffracted light beam are overlapped. Optical phases are shifted by 180 degrees between the areas 31b, 31a and the areas 31d, 31f, and optical phases are shifted by 180 degrees between the areas 31c, 31a and the areas 31g, 31h. At this time, a polarity of a second sub beam push-pull signal is inverted with respect to a main beam push-pull signal.

In the present invention, when the disc 7 is in the groove recording system with a narrow pitch of grooves, a difference between a main beam push-pull signal and a first sub beam push-pull signal is a tracking error signal, and a summation of a main beam push-pull signal and a first sub beam push-pull signal is a lens position signal. Further, when the disc 7 is in the land-and-groove recording system with a wide pitch of grooves, a difference between a main beam push-pull signal and a second sub beam push-pull signal is a tracking error signal, and a summation of a main beam push-pull signal and a second sub beam push-pull signal is a lens position signal.

In this case, when the disc 7 is in the groove recording system with a narrow pitch of grooves, a phase distribution of the first sub beams is set so that a first sub beam push-pull signal and a main beam push-pull signal have opposite polarities to each other. Further, when the disc 7 is in the land-and-groove recording system with a wide pitch of grooves, a phase distribution of the second sub beams is set so that a second sub beam push-pull signal and a main beam push-pull signal have opposite polarities to each other. Accordingly, an offset due to lens shift does not occur on a tracking error signal with respect to both two types of discs having different groove pitches and, in addition, a groove crossing noise does not occur in a lens position signal. Further, one focal spot of the main beam, two focal spots of the first sub beam, and two focal spots of the second sub beam are arranged on a same track of the disc 7. With this, an offset does not occur on the tracking error signal during continuous recording on a disc with two layers, and also amplitude of a tracking error signal is not varied much even with an eccentricity of the disc.

A cross-sectional view of the diffractive optical element 3b according to the exemplary embodiment is the same as in FIGS. 7A-7D. When the dielectric bodies 16 in the areas 13e, 13f, 13g, 13g, 13i of the diffractive optical element 3b are set in cross-sectional shapes shown in FIG. 7B, 7D, 7D, 7A, 7A, phases are shifted by 180 degrees between the positive and negative first order diffracted light beams from the areas 13e, 13f, 13g and the positive and negative first order diffracted light beams from the areas 13h, 13i, and phases are shifted by 180 degrees between the positive and negative second order diffracted light beams from the area 13e and the positive and negative second order diffracted light beams from the areas 13f, 13g, 13h, 13i.

In this case, the phase distribution of the first sub beam and the phase distribution of the second sub beam in the first exemplary embodiment may be opposite to each other. Further, the phase distribution of the first sub beam and the phase distribution of the second sub beam in the second exemplary embodiment may be opposite each other. Further, an exemplary embodiment, in which the phase distribution of the first sub beams in the first exemplary embodiment and the phase distribution of the first sub beams in the second exemplary embodiment are exchanged for each other, may be possible. Furthermore, an exemplary embodiment, in which the phase distribution of the second sub beams in the first exemplary embodiment and the phase distribution of the second sub beams in the second exemplary embodiment are exchanged for each other, may be possible.

FIG. 10 shows a third exemplary embodiment of an optical head device according to the invention. In the present invention, the diffractive optical element 3a is replaced with two diffractive optical elements 11a, 11b, and variable wavelength plates 12a and 12b are added in between the collimator lens 2 and the diffractive optical element 11a, and in between the diffractive optical element 11b and the polarization beam splitter 4 respectively, and then the photodetector 10a is replaced with a photodetector 10b, with respect to the first exemplary embodiment.

The diffractive optical elements 11a and 11b transmit a polarization component in a specific direction of an incoming light beam, and split a polarization component orthogonal to it into three light beams, that is, a zeroth order light beam and positive and negative first order diffracted light beams. Further, the variable wavelength plates 12a and 12b are liquid crystal optical elements having liquid crystal molecules, and vary or do not vary a polarization direction of an incoming light by 90 degree. In this case, an X axis and a Y axis are set in directions of a P polarization light beam and an S polarization light beam with respect to the polarization beam splitter 4, and a Z axis is set in a travelling direction of a light beam.

When the liquid crystal optical elements are not applied with a voltage, the liquid crystal molecules are oriented at 45 degrees with respect to the X and Y axes in a X-Y plane. An emitting light beam from the semiconductor laser 1 injects into the variable wavelength plate 12a as a linear polarization in the X axis direction. When this light beam is transmitted by the liquid crystal optical element, phase difference occurs between a polarization component in a parallel direction to the liquid crystal molecules and a polarization component in an orthogonal direction to the liquid crystal molecules. This phase difference is set to be a 180-degree, so that the polarization direction of the light beam transmitted by the crystal optical element is varied by 90 degrees. That is, an emitting light beam from the variable wavelength plate 12a injects into the diffractive optical element 11a as a linear polarization in the Y axis direction. The specific direction in the diffractive optical element 11a is the X axis direction. Therefore, this light beam is split into three light beams, which are a zeroth order light beam and positive and negative first order diffracted light beams by the diffractive optical element 11a, and they inject into the diffractive optical element 11b as the linear polarizations in the Y axis direction. The specific direction in the diffractive optical element 11b is the Y axis direction. Therefore, those light beams are transmitted by the diffractive optical element 11b, and inject into the variable wavelength plate 12b as the linear polarizations in the Y axis direction. When those light beams are transmitted by the liquid crystal optical element, phase difference occurs between a polarization component in the parallel direction to the liquid crystal molecules and a polarization component in the orthogonal direction to the liquid crystal molecules. The phase difference is set to be a 180-degree, so that polarization directions of the light beams transmitted by the crystal optical element are varied by 90 degrees. That is, emitting light beams from the variable wavelength plate 12b travel to the polarization beam splitter 4 as linear polarizations in the X axis direction.

On the other hand, when the liquid crystal optical elements are applied with a voltage, the liquid crystal molecules are oriented in the Z axis direction. An emitting light beam from the semiconductor laser 1 injects into the variable wavelength plate 12a as a linear polarization in the X axis direction. Phase difference does not occur even if this light beam is transmitted by the liquid crystal optical element. Therefore, the polarization direction of the light beam transmitted by the crystal optical element is not varied. That is, an emitting light beam from the variable wavelength plate 12a injects into the diffractive optical element 11a as the linear polarization in the X axis direction. The specific direction in the diffractive optical element 11a is the X axis direction, so that this light beam is transmitted by the diffractive optical element 11a and injects into the diffractive optical element 11b as the linear polarization in the X axis direction. The specific direction in the diffractive optical element 11b is the Y axis direction. Therefore, this light beam is split into three light beams, which are a zeroth order light beam and positive and negative first order diffracted light beams by the diffractive optical element 11b, and they inject into the variable wavelength plate 12b as linear polarization light beams in the X axis direction. Phase difference does not occur even if those light beams are transmitted by the crystal optical element, so that polarization directions of the light beams transmitted by the crystal optical element are not varied. That is, emitting light beams from the variable wavelength plate 12b travel to the polarization beam splitter 4 as the linear polarizations in the X axis direction.

Namely, an emitting light beam from the semiconductor laser 1 is split into three light beams in total, which are one light beam being the main beam and two light beams being the sub beam by the diffractive optical element 11a and 11b. When the liquid crystal optical elements are not applied with a voltage, the main beam is the zeroth order light beam from the diffractive optical elements 11a and 11b, and the sub beam is the positive and negative first order diffracted light beams from the diffractive optical element 11a that is the zeroth order light beam from the diffractive optical element 11b. On the other hand, when the liquid crystal optical elements are applied with a voltage, the main beam is the zeroth order light beam from the diffractive optical elements 11a and 11b and the sub beam is the zeroth order light beam from the diffractive optical element 11a that is the positive and negative first order diffracted light beams from the diffractive optical element 11b.

FIG. 11A is a plan view of the diffractive optical element 11a. The diffractive optical element 11a has a diffraction grating formed on its whole surface including the effective diameter 6a of the objective lens 6 indicated by dotted lines in the drawing, wherein the diffraction grating is divided into two areas 14a and 14b by a line passing through an optical axis of an incoming light beam and parallel to the tangential direction of the disc 7. Each grating direction in the diffraction grating is parallel to the radial direction of the disc 7, and each grating pattern has a linear shape with even pitch. Grating pitches over the areas 14a and 14b are even.

FIG. 11B is a plan view of the diffractive optical element 11b. The diffractive optical element 11b has a diffraction grating formed on its whole surface including the effective diameter 6a of the objective lens 6 indicated by dotted lines in the drawing, wherein the diffraction grating is divided into four areas 14c-14f by three lines symmetric with respect to an optical axis of an incoming light and parallel to the tangential direction of the disc 7. Each grating direction of the diffraction grating is parallel to the radial direction of the disc 7, and each grating pattern has a linear shape with even pitch. Grating pitches over the areas 14c-14f are even. In this case, assuming that a wavelength of the semiconductor laser 1 is λ, a numerical aperture of the objective lens 6 is NA, and a groove pitch is Tp2 when the disc 7 is in the land-and-groove recording system with a wide pitch of grooves, then both ratios of widths of the areas 14c and 14d with respect to the effective diameter 6a of the objective lens 6 are λ/(2·NA·Tp2) respectively.

When the liquid crystal optical elements composing the variable wavelength plates 12a and 12b are not applied with a voltage, an incoming light beam into the diffractive optical element 11a, for example, is transmitted by about 87.3% to be the zeroth order light beam, and is diffracted by about 5.1% each to be the positive and negative first order diffracted light beams. Meanwhile, an incoming light beam into the diffractive optical element 11b is transmitted by almost 100%. Phases are shifted by 180 degrees between the positive and negative first order diffracted light beams from the area 14a and the positive and negative first order diffracted light beams from the area 14b. Consequently, the main beam and the sub beams have different phase distributions from each other. Then, the phase distribution of the sub beam is a first phase distribution.

On the other hand, when the liquid crystal optical elements composing the variable wavelength plate 12a and 12b are applied with a voltage, an incoming light beam into the diffractive optical element 11b, for example, is transmitted by the diffractive optical element 11b by about 87.3% to be the zeroth order light beam, and is diffracted by the diffractive optical element 11b by about 5.1% each to be the positive and negative first order diffracted light beams. Meanwhile, an incoming light beam into the diffractive optical element 11a is transmitted almost by 100%. Phases are shifted by 180 degrees between the positive and negative first order diffracted light beams from the areas 14c, 14f and the positive and negative first order diffracted light beams from the areas 14d and 14e. Consequently, the main beam and the sub beams have different phase distributions from each other. Then, the phase distribution of the sub beams is a second phase distribution.

Each of FIGS. 12A and 12B shows an arrangement of focal spots on the disc 7. FIG. 12A shows a case with the disc 7 in the groove recording system with a narrow pitch of grooves, and FIG. 12B shows a case with the disc 7 in the land-and-groove recording system with a wide pitch of grooves.

When the disc 7 is in the groove recording system with a narrow pitch of grooves, the liquid crystal optical elements composing the variable wavelength plates 12a and 12b are not applied with a voltage. Then, focal spots 22a, 22b, 22c correspond to the zeroth order light beam from the diffracted optical elements 11a and 11b, the positive first order diffracted light beam from the diffractive optical element 11a that is the zeroth order light beam from the diffracted optical element 11b, and the negative first order diffracted light beam from the diffractive optical element 11a that is the zeroth order light beam from the diffractive optical element 11b. The focal spots 22a, 22b, 22c are arranged on the same track 20a of a groove. The focal spots 22b and 22c of the sub beam have two peaks in the same intensity in the right and left sides of the radial direction of disc 7.

When the disc 7 is in the land-and-groove recording system with a wide pitch of grooves, the liquid crystal optical elements composing the variable wavelength plates 12a and 12b are applied with a voltage. Then, the focal spots 22a, 22b, 22c correspond to the zeroth order light beam from the diffractive optical elements 11a and 11b, the zeroth order light beam from the diffractive optical element 11a that is the positive first order diffracted light beam from the diffractive optical element 11b, and the zeroth order light beam from the diffractive optical element 11a that is the negative first order diffracted light beam from the diffractive optical element 11b. The focal spots 22a, 22b, 22c are arranged on the same track 20b of a land or a groove. The focal spots 22b and 22c of the sub beam have two peaks in the same intensity in the right and left side of the radial direction of the disc 7.

FIG. 13 shows a pattern with light receiving sections of the photodetector 10b and an arrangement of the optical spots on the photodetector 10b. An optical spot 26a corresponds to the zeroth order light beam from the diffractive optical elements 11a and 11b, and it is received by four of light receiving sections 25a-25d into which a light receiving section is divided by a dividing line passing through an optical axis and parallel to the tangential direction of the disc 7 and a dividing line passing through the optical axis and parallel to the radial direction of the disc 7. An optical spot 26b corresponds to the positive first order diffracted light beam from the diffractive optical element 11a and the zeroth order light beam from the diffractive optical element 11b when a voltage is not applied to the liquid crystal optical elements composing the variable wavelength plates 12a and 12b, and corresponds to the zeroth order light beam from the diffractive optical element 11a that is the positive first order diffracted light beam from the diffractive optical element 11b when a voltage is applied to, and it is received by the light receiving sections 25e and 25f into which a light receiving section is divided by a dividing line passing through an optical axis and parallel to the radial direction of the disc 7. An optical spot 26c corresponds to the negative first order diffracted light beam from the diffractive optical element 11a that is the zeroth order light beam from the diffractive optical element 11b when a voltage is not applied to the liquid crystal optical elements composing the variable wavelength plates 12a and 12b, and corresponds to the zeroth order light beam from the diffractive optical element 11a that is the negative first order diffracted light beam from the diffractive optical element 11b when a voltage is applied to, and then it is received by two of light receiving sections 25g and 25h into which a light receiving section is divided by a dividing line passing through an optical axis and parallel to the radial direction of the disc 7. In the optical spots 26a-26c, intensity distributions in the tangential direction and intensity distributions in the radial direction of the disc 7 are exchanged for each other depending on effects of the cylindrical lens 8 and the convex lens 9.

When outputs from the light receiving sections 25a-25h are expressed by V25a−V25h, a focus error signal can be obtained by an equation of (V25a+V25d)−(V25b+V25c) according to the astigmatic method. A main beam push-pull signal is given by (V25a+V25b)−(V25c+V25d), a sub beam push-pull signal is given by (V25e+V25g)−(V25f+V25h). A difference between the main beam push-pull signal and the sub beam push-pull signal is a tracking error signal, and a summation of the main beam push-pull signal and the sub beam push-pull signal is a lens position signal. An RF signal recorded on the disc 7 can be obtained by an equation of (V25a+V25b+V25c+V25d).

Various push-pull signals relating to detection of the tracking error signal and the lens position signal according to the exemplary embodiment are the same as in FIGS. 5A-5D. In the exemplary embodiment, as in the same manner with the first exemplary embodiment, an offset due to lens shift does not occur on the tracking error signal, in addition, a groove crossing noise does not occur on the lens position signal.

In the exemplary embodiment, when the disc 7 is in the groove recording system with a narrow pitch of grooves, a phase distribution of the sub beams reflected by the disc 7 and diffracted by the disc 7 (the first phase distribution) is the same as in FIG. 6A. In the exemplary embodiment, as in the same manner with the first exemplary embodiment, a polarity of a sub beam push-pull signal having the first phase distribution is inverted with respect to a main beam push-pull signal. Further, in the exemplary embodiment, when the disc 7 is in the land-and-groove recording system with a wide pitch of grooves, a phase distribution of the sub beam reflected by the disc 7 and diffracted by the disc 7 (the second phase distribution) is the same as in FIG. 6B. In the exemplary embodiment, as in the same matter with the first exemplary embodiment, a polarity of a sub beam push-pull signal having the second phase distribution is inverted with respect to a main beam push-pull signal.

In the exemplary embodiment, when the disc 7 is in the groove recording system with a narrow pitch of grooves, a phase distribution of the sub beams is the first phase distribution and, at the same time, a difference between a main beam push-pull signal and a sub beam push-pull signal is a tracking error signal, and a summation of a main beam push-pull signal and a sub beam push-pull signal is a lens position signal. Further, when the disc 7 is the land-and-groove recording system with a wide pitch of grooves, a phase distribution of the sub beam is the second phase distribution and, at the same time, a difference between a main beam push-pull signal and a sub beam push-pull signal is a tracking error signal, and a summation of a main beam push-pull signal and a sub beam push-pull signal is a lens position signal.

In this case, when the disc 7 is in the groove recording system with a narrow pitch of grooves, the first phase distribution is set so that a sub beam push-pull signal and a main beam push-pull signal have opposite polarities to each other. Further, when the disc 7 is in the land-and-groove recording system with a wide pitch of grooves, the second phase distribution is set so that a sub beam push-pull signal and a main beam push-pull signal have opposite polarities to each other. Accordingly, an offset due to lens shift does not occur on a tracking error signal and a groove crossing noise does not occur in a lens position signal, with respect to two types of discs having different groove pitches. Furthermore, one focal spot of the main beam and two focal spots of sub beam are arranged on a same track of the disc 7. Accordingly, an offset does not occur on the tracking error signal during continuous recording on a disc with two layers and amplitude of a tracking error signal is not varied much even with an eccentricity of the disc.

In the exemplary embodiment, the liquid crystal optical elements having liquid crystal molecules are used as the variable wavelength plates 12a and 12b, but half wavelength plates having a rotation mechanism rotating around the Z axis can be used as the variable wavelength plates 12a and 12b.

In this case, when the half wavelength plates are not rotated, an optical axis of the half wavelength plates is parallel to a 45-degree direction with respect to the X axis and the Y axis in the X-Y plane. An emitting light beam from the semiconductor laser 1 injects into the variable wavelength plate 12a as a linear polarization in an X axis direction. When this light beam is transmitted by the half wavelength plate, phase difference occurs between a polarization component in a parallel direction to the optical axis and a polarization component in an orthogonal direction to the optical axis. This phase difference is set in a 180-degree. Therefore, a polarization direction of the light beam transmitted by the half wavelength plate is varied by 90 degrees. That is, an emitting light beam from the variable wavelength plate 12a injects into the diffractive optical element 11a as a linear polarization in the Y axis direction. The specific direction in the diffractive optical element 11a is the X axis direction. Therefore, this light beam is split into three light beams, which are the zeroth order light beam and the positive and negative first order diffracted light beams by the diffractive optical element 11a, and they inject into the diffractive optical element 11b as the linear polarizations in the Y axis direction. The specific direction in the diffractive optical element 11b is the Y axis direction. Therefore, those light beams are transmitted by the diffractive optical element 11b and inject into the variable wavelength plate 12b as the linear polarizations in the Y axis direction. When those light beams are transmitted by the half wavelength plate, phase difference occurs between a polarization component in the parallel direction to the optical axis and a polarization component in the orthogonal direction to the optical axis. This phase difference is set in a 180-degree. Therefore, a polarization direction of light beams transmitted by the half wavelength plate is varied by 90 degree. That is, emitting light beams from the variable wavelength plate 12b travel to the polarization beam splitter 4 as linear polarizations in the X axis direction.

Meanwhile, when the half wavelength plates are rotated by 45 degrees, the optical axis of the half wavelength plates are parallel to the X axis direction or the Y axis direction in the X-Y plain. An emitting light beam from the semiconductor laser 1 injects into the variable wavelength plate 12a as a linear polarization in the X axis direction. Phase difference does not occur even if this light beam is transmitted by the half wavelength plate, so that a polarization direction of the light beam transmitted by the half wavelength plate is not varied. That is, an emitting light beam from the variable wavelength plate 12a injects into the diffractive optical element 11a as the linear polarization in the X axis direction. The specific direction in the diffractive optical element 11a is the X axis direction. Therefore, this light beam is transmitted by the diffractive optical element 11a, and injects into the diffractive optical element 11b as the linear polarization in the X axis direction. The specific direction in the diffractive optical element 11b is the Y axis direction. Therefore, this light beam is split into three light beams, which are the zeroth order light beam and the positive and negative first order diffracted light beams by the diffractive optical element 11b, and they inject into the variable wavelength plate 12b as the linear polarizations in the X axis direction. Phase difference does not occur even if those light beams are transmitted by the half wavelength plate. Therefore, a polarization direction of light beams transmitted by the half wavelength plate is not varied. That is, emitting light beams from the variable wavelength plate 12b travel to the polarization beam splitter 4 as the linear polarizations in X direction.

FIGS. 14A and 14B are cross-sectional views of the diffractive optical elements 11a and 11b. The diffractive optical elements 11a and 11b have substrates 17a and 17b which include liquid crystal polymer 18 with birefringence and a filler 19 in between thereof. The liquid crystal polymer 18 is in a cross-sectional shape of repetition of a line section with a width of P/2 and a space section with a width of P/2 in FIG. 14A, and repetition of a space section with a width of P/2 and a line section with a width of P/2 in FIG. 14B. That is, each interval of gratings is P. A difference in heights between the line sections and the space sections is H2.

In this case, assuming that a wavelength of the semiconductor laser 1 is λ, a difference between a refraction index of the liquid crystal polymer 18 with respect to an ordinary beam and a refraction index of the filler 19 is Δno, a difference between a refraction index of the liquid crystal polymer 18 with respect to an extraordinary beam and a refraction index of the filler 19 is Δne, a transmissivity and diffraction efficiencies of positive and negative first order of the diffractive optical elements 11a and 11b with respect to an ordinary beam are ηo0, ηo1 respectively, and a transmissivity and diffraction efficiencies of positive and negative first order of the diffractive optical elements 11a and 11b with respect to an extraordinary beam are ηe0, ηe1 respectively, then the following equations (5)-(10) are satisfied.

ηo0=cos²(φo/2) (5)

ηo1=(2/π)² sin²(φo/2) (6)

φo=4πΔnoH2/λ (7)

ηe0=cos²(φe/2) (8)

ηe1=(2/π)² sin²(φe/2) (9)

φe=4πΔneH2/λ (10)

For example, assuming that a polarization component in a same direction with the ordinary beam is φo=0, then ηo0=1, ηo1=0. That is, a light beam injecting into the diffractive optical elements 11a and 11b is transmitted by almost 100% to be the zeroth order light beam. Further, assuming that a polarization component in a same direction with the extraordinary beam is φe=0.194π, then ηe0=0.910, ηe1=0.036. That is, a light beam injecting into the diffractive optical elements 11a and 11b is transmitted by about 91.0% to be the zeroth order light beam, and is diffracted by about 3.6% each to be the positive and negative first order diffracted light beams.

When the liquid crystal polymers 18 in the areas 14a and 14b in the diffractive optical element 11a are set as in FIGS. 14A, 14B respectively, a phase shift is 180 degrees between the positive and negative first order diffracted light beams from the area 14a and the positive and negative first order diffracted light beams from the area 14b. Further, when the liquid crystal polymers 18 in the areas 14c, 14d, 14e, 14f of the diffractive optical element 11b are set as in FIGS. 14A, 14B, 14B, 14A, a phase shift is 180 degrees between the positive and negative first order diffracted light beams from the areas 14c, 14f and the positive and negative first order diffracted light beams from the areas 14d, 14e.

In a fourth exemplary embodiment of an optical head device according to the present invention, the diffractive optical elements 11a and 11b in the third exemplary embodiment are replaced with for diffractive optical elements 11c and 11d shown in FIGS. 15A and 15B respectively. The diffractive optical elements 11c and 11d transmit a polarization component in a specific direction out of an incoming light beam, and split a polarization component in a direction orthogonal to it into three light beams, which are a zeroth order light beam and positive and negative first order diffracted light beams.

FIG. 15A is a plan view of the diffractive optical element 11. The diffractive optical element 11c has a diffraction grating formed on a whole surface thereof including the effective diameter 6a of the objective lens 6 indicated by dotted lines in the drawing, wherein the diffraction grating is divided into three areas 14g-14i by two lines passing through an optical axis of an incoming light beam and parallel to the tangential direction of the disc 7. Each grating direction in the diffraction grating is parallel to the radial direction of the disc 7, and each grating pattern is in a linear shape with even pitch. Pitches of the gratings over the areas 14g-14i are even. In this case, assuming that a wavelength of the semiconductor laser 1 is λ, a numerical aperture of the objective lens 6 is NA, and a groove pitch is Tp1 when the disc 7 is in the groove recording system with a narrow pitch of grooves, then a ratio of a width of the area 14g with respect to the effective diameter 6a of the objective lens 6 is λ/(2·NA·Tp1).

FIG. 15B is a plan view of the diffractive optical element 11d. The diffractive optical element 11d has a diffraction grating formed on a whole surface thereof including the effective diameter 6a of the objective lens 6 indicated by dotted lines in the drawing, wherein the diffraction grating is divided into three areas 14j-14l by two lines passing through an optical axis of an incoming light beam and parallel to the tangential direction of the disc 7. Each grating direction in the diffraction grating is parallel to the radial direction of the disc 7, and each grating pattern is in a linear shape with even pitch. Pitches of the gratings over the areas 14j-14l are even. In this case, assuming that a wavelength of the semiconductor laser 1 is λ, a numerical aperture of the objective lens 6 is NA, and a groove pitch is Tp2 when the disc 7 is in the land-and-groove recording system with a wide pitch of grooves, then a ratio of a width of the area 14j with respect to the effective diameter 6a of the objective lens 6 is λ/(2·NA·Tp2).

When the liquid crystal optical elements composing the variable wavelength plates 12a and 12b are not applied with a voltage, an incoming light beam into the diffractive optical element 11c, for example, is transmitted by almost 87.3% to be the zeroth order light beam, and is diffracted by almost 5.1% each to be the positive and negative first order diffracted light beams. Meanwhile, an incoming light beam into the diffractive optical element 11d is transmitted by almost 100%. A phase shift is 180 degrees between the positive and negative first order diffracted light beams from the area 14g and the positive and negative first order diffracted light beams from the areas 14h and 14i. Consequently, the main beam and the sub beams have different phase distributions from each other. Then, the phase distribution of the sub beams is a first phase distribution.

On the other hand, when the liquid crystal optical elements composing the variable wavelength plates 12a and 12b are applied with a voltage, an incoming light beam into the diffractive optical element 11d, for example, is transmitted by about 87.3% to be the zeroth order light beam, and is diffracted by about 5.1% each to be the positive and negative first order diffracted light beams. Meanwhile, an incoming light beam into the diffractive optical element 11c is transmitted by almost 100%. A phase shift is 180 degrees between the positive and negative first order diffracted light beams from the area 14j and the positive and negative first order diffracted light beam from the areas 14k and 14l. Consequently, the main beam and the sub beams have different phase distributions from each other. Then, the phase distribution of the sub beams is a second phase distribution.

An arrangement of focal spots on the disc 7 according to the exemplary embodiment is the same as in FIGS. 12A and 12B. In the exemplary embodiment, as in the same manner with the third exemplary embodiment, one focal spot of the main beam and two focal spots of the sub beam are arranged on a same track of the disc 7.

A pattern with the light receiving sections of the photodetector 10b and an arrangement of optical spots on the photodetector 10b in the exemplary embodiment are the same as in FIG. 13. In the exemplary embodiment, as in the same manner with the third exemplary embodiment, a focus error signal, a main beam push-pull signal, a sub beam push-pull signal, and an REF signal recorded on the disc 7 can be obtained. A difference between the main beam push-pull signal and the sub beam push-pull signal is a tracking error signal, and a summation of the main beam push-pull signal and the sub beam push-pull signal is a lens position signal.

Various push-pull signals related to detecting of the tracking error signal and the lens position signal according to the exemplary embodiment are the same as in FIGS. 5A-5D. In the present invention, as in the same manner with the third exemplary embodiment, an offset due to lens shift does not occur on the tracking error signal and, in addition, a groove crossing noise does not occur on the lens position signal.

In the present invention, a phase distribution of the sub beams reflected by the disc 7 and the sub beams diffracted by the disc 7 in a case with the disc 7 in the groove recording system with a narrow pitch of grooves (the first phase distribution) is the same as in FIG. 9A. In the present invention, as in the same manner with the second exemplary embodiment, a sub beam push-pull signal having the first phase distribution has its polarity inverted with respect to a main beam push-pull signal. Further, in the exemplary embodiment, a phase distribution of the sub beams reflected by the disc 7 and the sub beams diffracted by the disc 7 in the land-and-groove recording system with a wide pitch of grooves (the second phase distribution) is the same as in FIG. 9B. In the exemplary embodiment, as in the same manner with the second exemplary embodiment, a sub beam push-pull signal having the second phase distribution has its polarity inverted with respect to a main beam push-pull signal.

In the exemplary embodiment, when the disc 7 is in the groove recording system with a narrow pitch of grooves, a phase distribution of the sub beams is the first phase distribution, at the same time, a difference between a main beam push-pull signal and a sub beam push-pull signal is a tracking error signal, and a summation of a main beam push-pull signal and a sub beam push-pull signal is a lens position signal. Further, when the disc 7 is in the land-and-groove recording system with a wide pitch of grooves, a phase distribution of the sub beams is the second phase distribution, at the same time, a difference between a main beam push-pull signal and a sub beam push-pull signal is a tracking error signal, and a summation of a main beam push-pull signal and a sub beam push-pull signal is a lens position signal.

In this case, when the disc 7 is in the groove recording system with a narrow pitch of grooves, the first phase distribution is set so that a sub beam push-pull signal and a main beam push-pull signal have opposite polarities to each other. Further, when the disc 7 is in the land-and-groove recording system with a wide pitch of grooves, the second phase distribution is set so that a sub beam push-pull signal and a main beam push-pull signal have opposite polarities to each other. Accordingly, an offset due to lens shift does not occur on the tracking error signal and, in addition, a groove crossing noise does not occur on the lens position signal, with respect to both two types of discs having different groove pitches. Further, one focal spot of the main beam and two focal spots of the sub beams are arranged on a same track of the disc 7. Accordingly, an offset does not occur on the tracking error signal during continuous recording on a disc with two layers and, in addition, amplitude of the tracking error signal is not varied much even with an eccentricity of the disc.

The diffractive optical elements 11c and 11d according to the exemplary embodiment have the same cross-sectional views as in FIGS. 14A and 14B. When cross-sectional shapes of the liquid crystal polymers 18 in the areas 14g, 14h, 14i of the diffractive optical element 11c are set as in FIGS. 14B, 14A, 14A, a phase shift is 190 degrees between the diffracted light beams of positive and negative first order from the area 14g and the positive and negative first order diffracted light beams from the areas 14h and 14i. Further, when cross-sectional shapes of the liquid crystal polymers 18 in the areas 14j, 14k, 14l of the diffractive optical element 11d are set as in FIGS. 14B, 14A, 14A, a phase shift is 180 degrees between the positive and negative first order diffracted light beams from the area 14j and the positive and negative first order diffractive light beams from the areas 14k and 14l.

The first phase distribution and the second phase distribution may be inverse to each other in the third exemplary embodiment. Also, the first phase distribution and the second phase distribution may be in inverse to each other in the fourth exemplary embodiment. Further, an exemplary embodiment can be possible where the first phase distribution in the third exemplary embodiment and the first phase distribution in the fourth exemplary embodiment are exchanged for each other. Moreover, an exemplary embodiment can be possible where the second phase distribution in the third exemplary embodiment and the second phase distribution in the fourth exemplary embodiment are exchanged for each other.

FIG. 16 shows a first exemplary embodiment of an optical information recording or reproducing apparatus according to the invention. This exemplary embodiment includes the optical head device in the first exemplary embodiment according to the present invention shown in FIG. 1 to which a calculation circuit 32 and a drive circuit 33 (33a, 33b) are added. The calculation circuit 32 calculates the tracking error signal and the lens position signal according to an output from each light receiving section of the photodetector 10a. When the optical head device performs a track-following operation with respect to the disc 7, the drive circuit 33a makes the objective lens 6 framed by dotted lines in the drawing follow a track on the disc 7 by using an unillustrated actuator so that a tracking error signal becomes zero, and the drive circuit 33b makes the whole optical head device except the objective lens 6 framed by the dotted lines in the drawing follow the objective lens 6 by using an unillustrated motor so that a lens position signal becomes zero. Further, when the optical head device performs a seek operation with respect to the disc 7, the drive circuit 33a makes the objective lens 6 framed by the dotted lines follow the whole optical head device except the objective lens 6 by using an unillustrated actuator so that a lens position signal becomes zero.

Other exemplary embodiments of an optical information recording or reproducing apparatus according to the invention may be considered where the optical head devices in the second to fourth exemplary embodiments have the calculation circuit and the drive circuit. In such a case, an exemplary embodiment including the optical head device of the third or fourth exemplary embodiment with the calculation circuit and the drive circuit further includes a control circuit (a control unit) for controlling the variable wavelength plates 12a and 12b. When the variable wavelength plates 12a and 12b are liquid crystal optical elements having liquid crystal molecules, the control circuit does not apply a voltage to the liquid crystal optical elements composing the variable wavelength plates 12a and 12b in a case with the disc 7 having a narrow pitch of grooves, and applies a voltage to the liquid crystal optical elements composing the variable wavelength plates 12a and 12b in a case with the disc 7 having a wide pitch of grooves. Further, when the variable wavelength plates 12a and 12b is half wavelength plates having a rotation mechanism rotating around the Z axis, the control circuit does not rotate the half wavelength plates composing the variable wavelength plates 12a and 12b in a case with the disc 7 having a narrow pitch of grooves, and rotates the half wavelength plates composing the variable wavelength plates by 45 degrees in a case with the disc 7 having a wide pitch of grooves.

### BRIEF DESCRIPTION OF THE DRAWINGS

FIG. 1 A configuration diagram showing a first exemplary embodiment of an optical head device according to the invention;

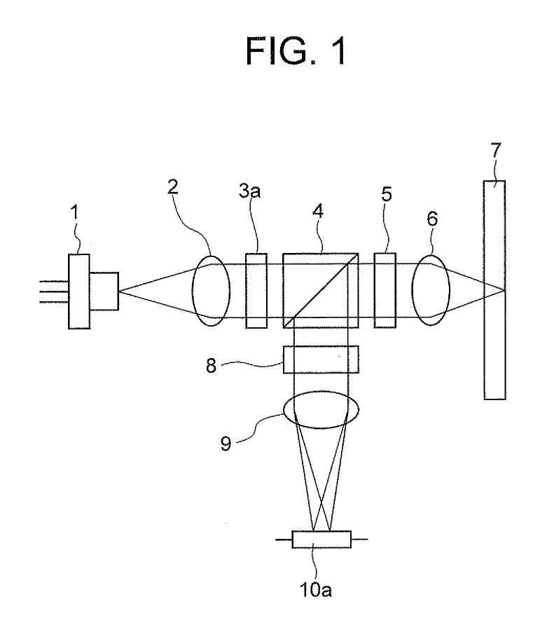

FIG. 2 A plan view showing a diffractive optical element in the first exemplary embodiment of the optical head device according to the invention;

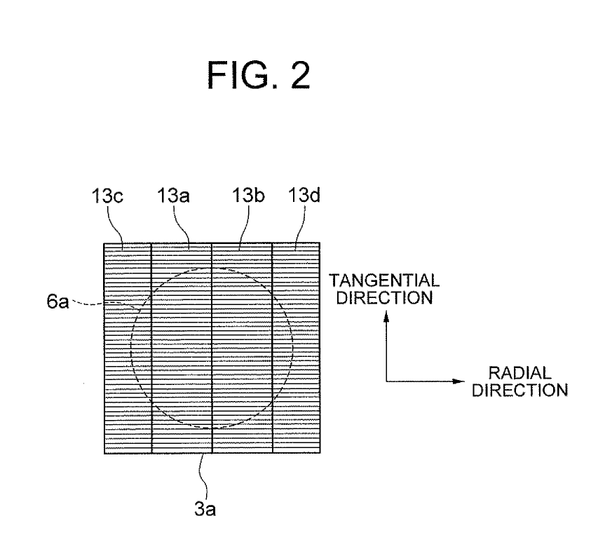

FIGS. 3A and 3B Plan views showing arrangements of focal spots on discs in the first exemplary embodiment of the optical head device according to the invention;

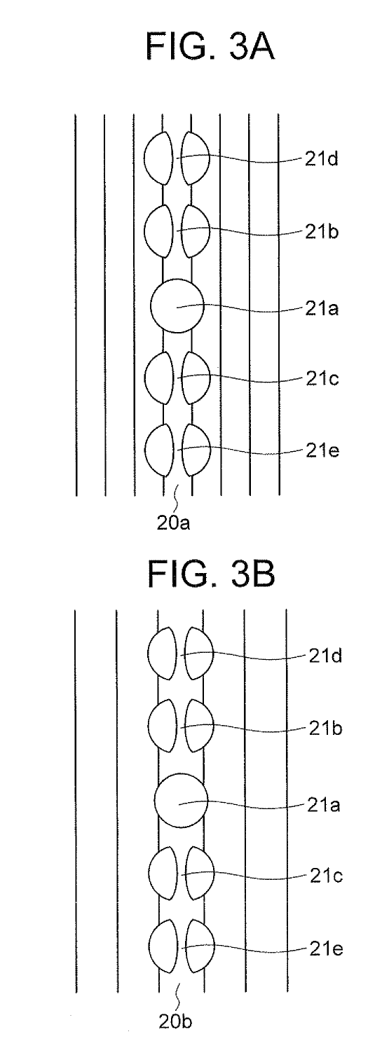

FIG. 4 A plan view showing a pattern with light receiving sections in a photodetector and an arrangement of optical spots on the photodetector in the first exemplary embodiment of the optical head device according to the invention;

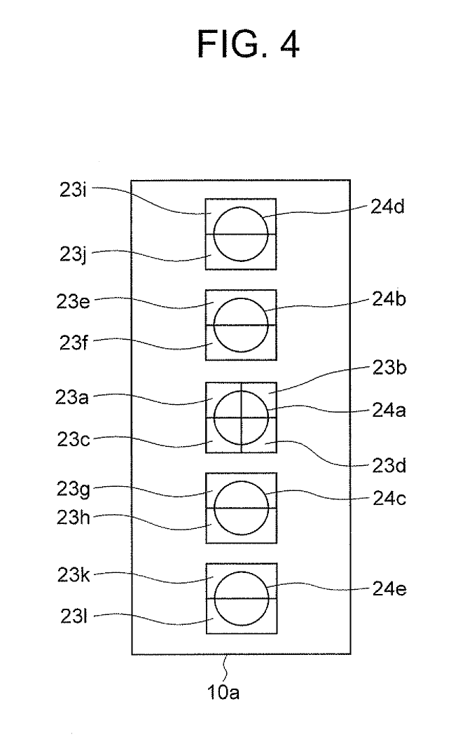

FIGS. 5A-5D Waveform charts showing variable push-pull signals relating to a tracking error signal and a lens position signal in the first exemplary embodiment of the optical head device according to the invention;

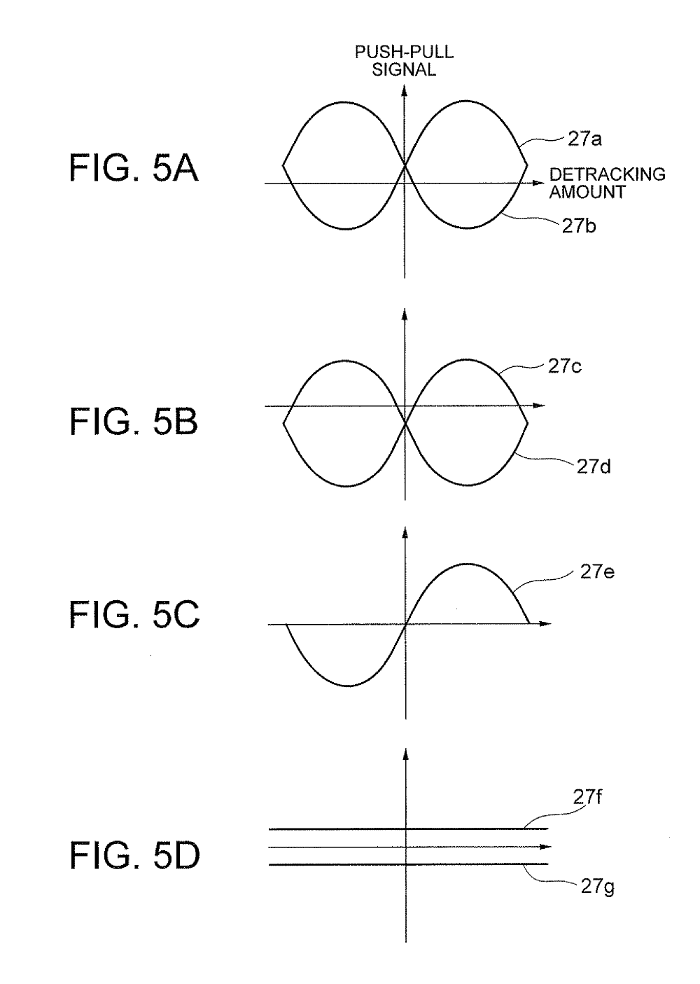

FIGS. 6A and 6B Diagrams showing phase distributions of a sub beam reflected by the disc and a sub beam diffracted by the disc in the first exemplary embodiment of the optical head device according to the invention;

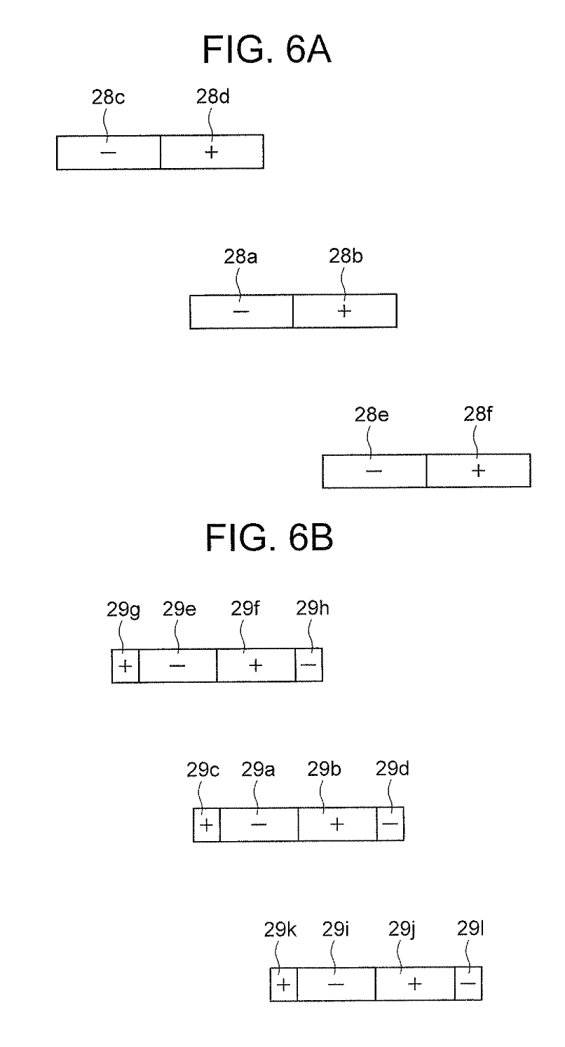

FIGS. 7A-7D Cross-sectional views showing a diffractive optical element in the first exemplary embodiment of the optical head device according to the invention;

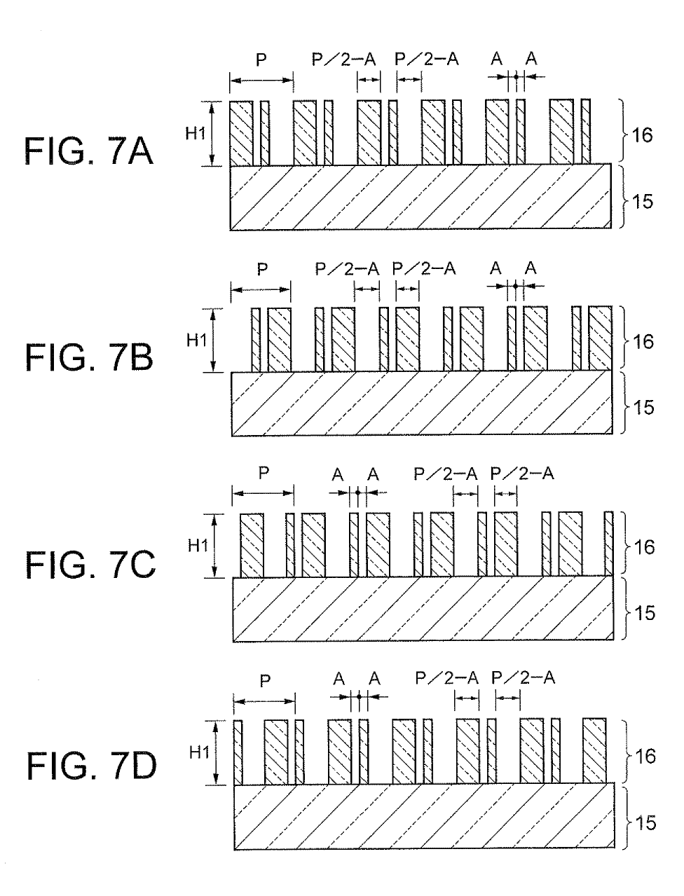

FIG. 8 A plan view showing a diffractive optical element of a second exemplary embodiment of an optical head device according to the invention;

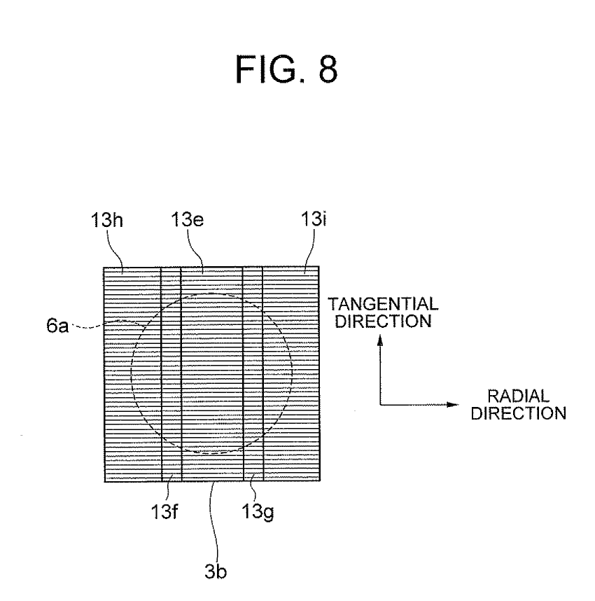

FIGS. 9A and 9B Diagrams showing phase distributions of a sub beam reflected by the disc and a sub beam diffracted by the disc in the second exemplary embodiment of the optical head device according to the invention;

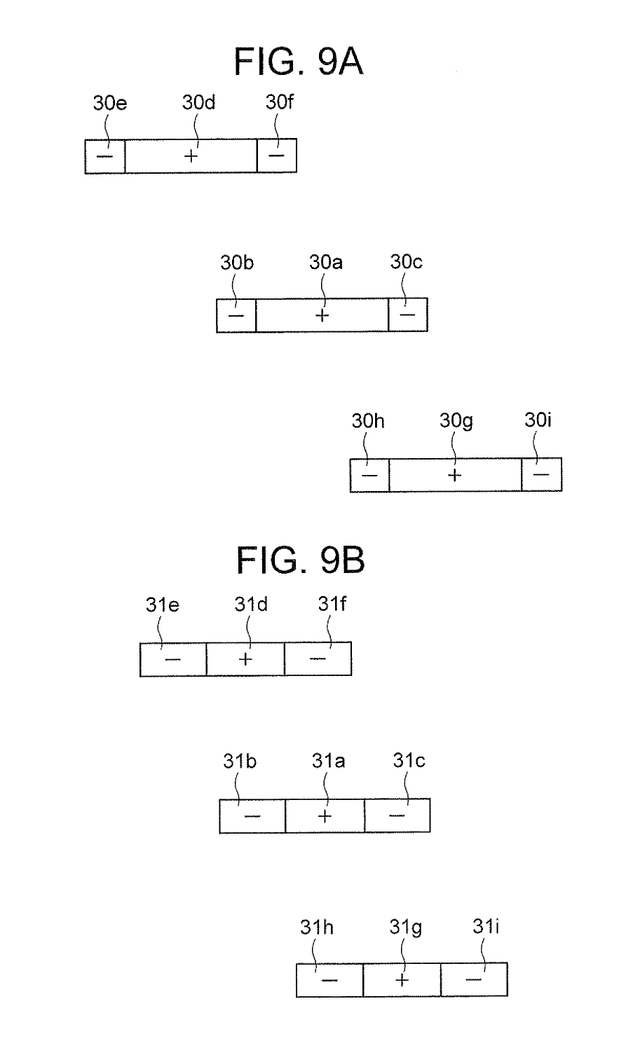

FIG. 10 A configuration diagram showing a third exemplary embodiment of an optical head device according to the invention;

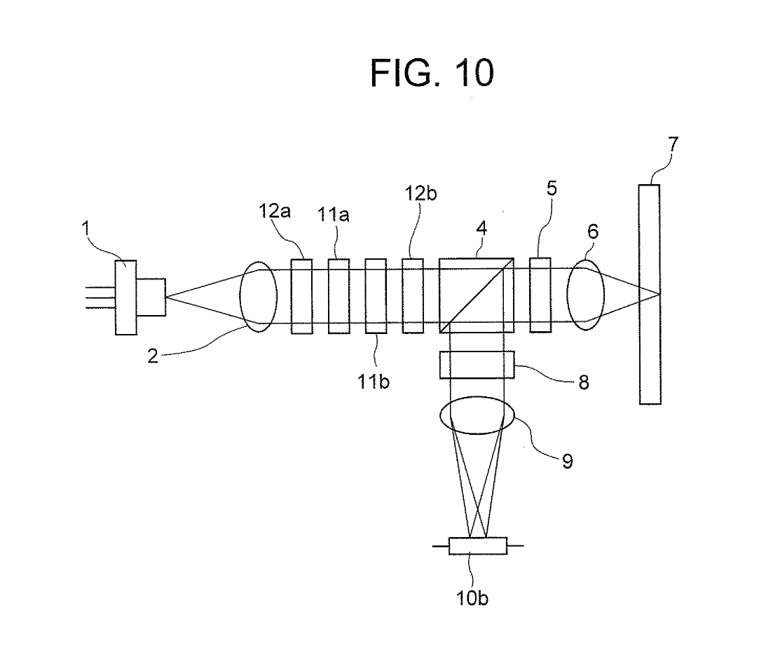

FIGS. 11A and 11B Plan views showing diffractive optical elements in the third exemplary embodiment of the optical head device according to the invention;

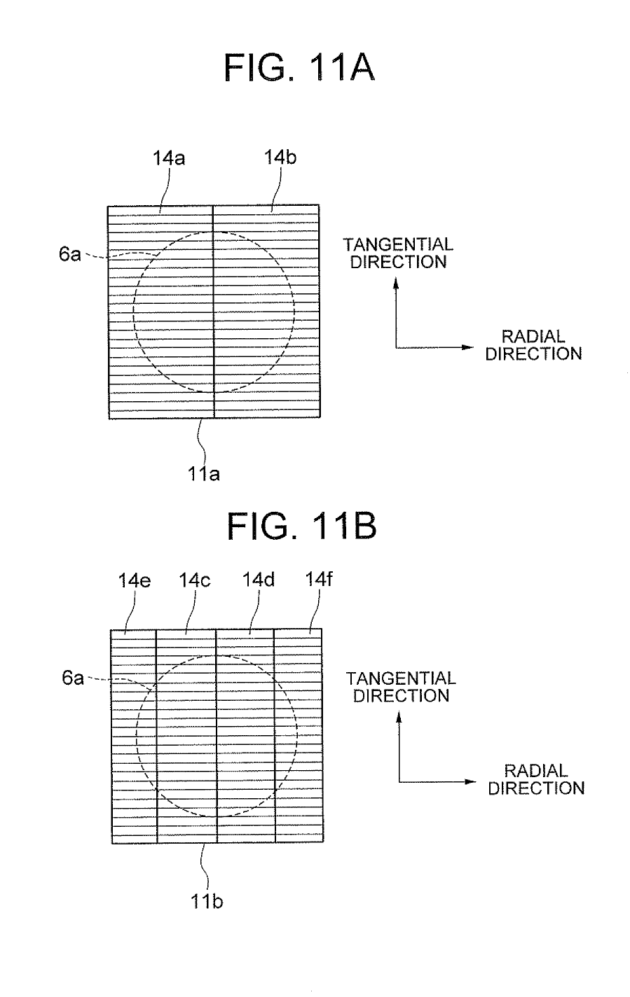

FIGS. 12A and 12B Plan views showing arrangements of focal spots in the third exemplary embodiment of the optical head device according to the invention;

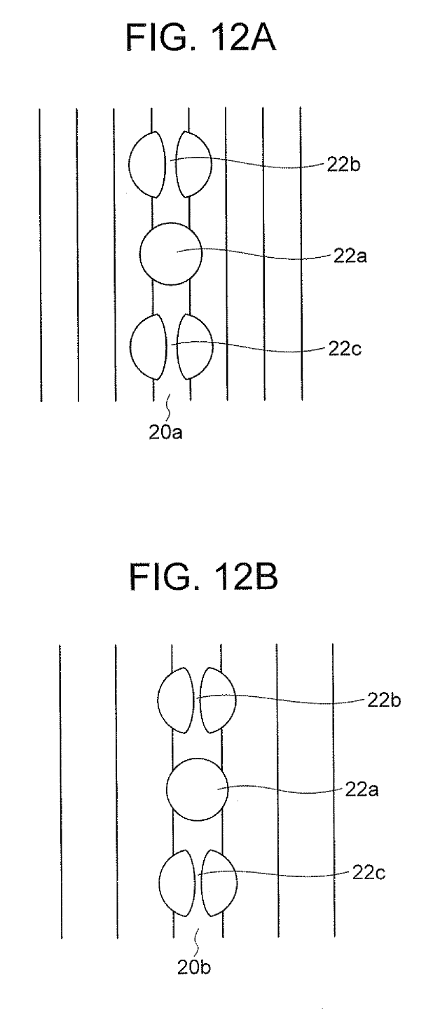

FIG. 13 A plan view showing a pattern with light receiving sections of a photodetector and an arrangement of optical spots on the photodetector in the third exemplary embodiment of the optical head device according to the invention;

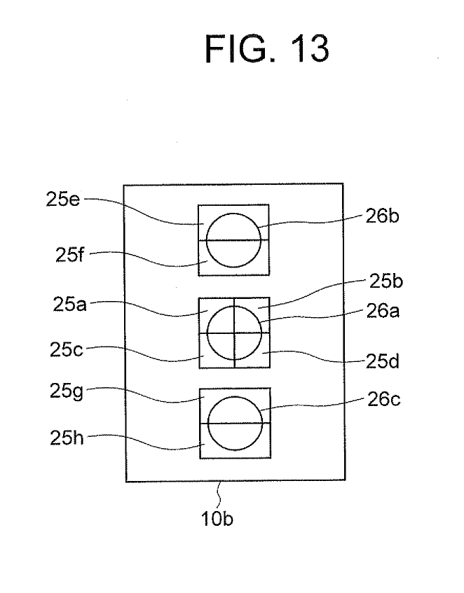

FIGS. 14A and 14B Cross-sectional views showing a diffractive optical element in the third exemplary embodiment of the optical head device according to the invention;

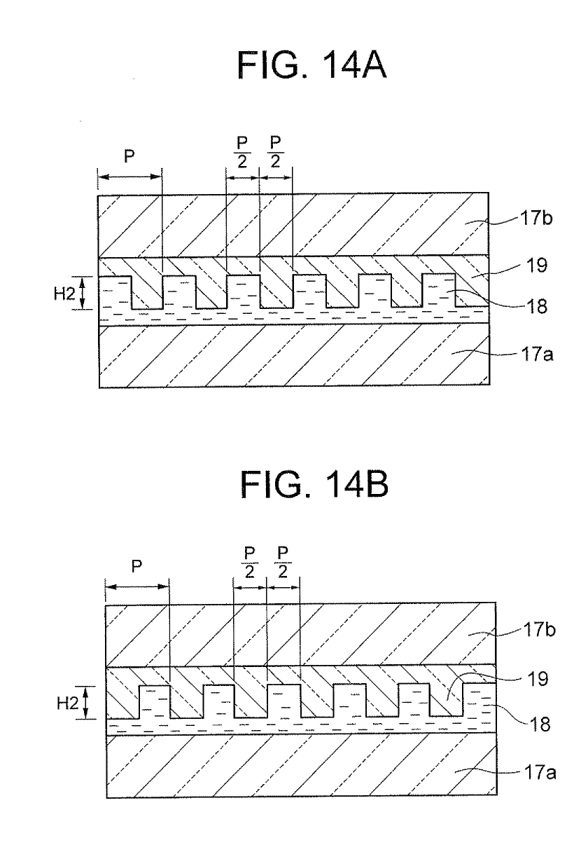

FIGS. 15A and 15B Plan views showing diffractive optical elements in a fourth exemplary embodiment of an optical head device according to the invention;

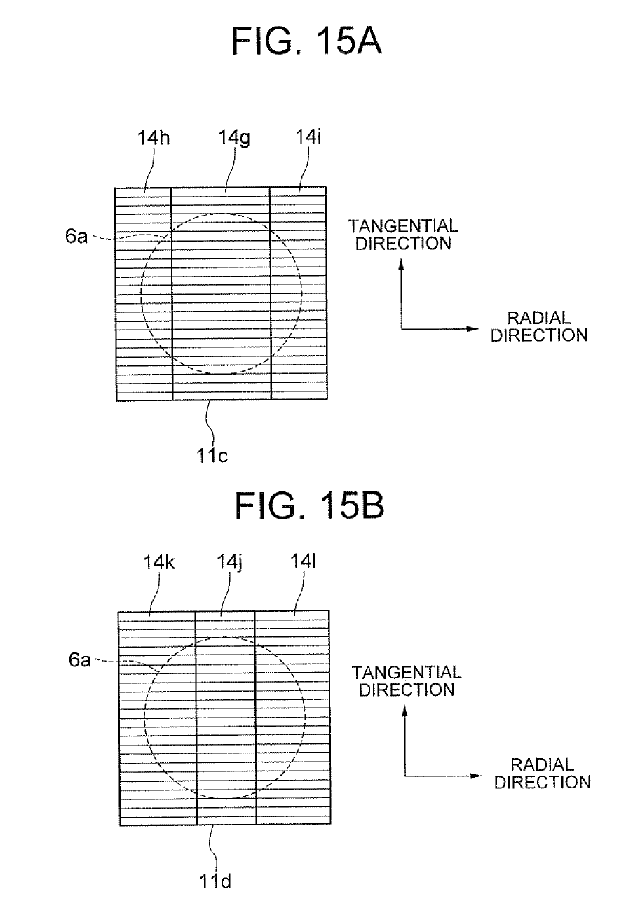

FIG. 16 A configuration diagram showing a first exemplary embodiment of an optical information recording or reproducing apparatus according to the invention;

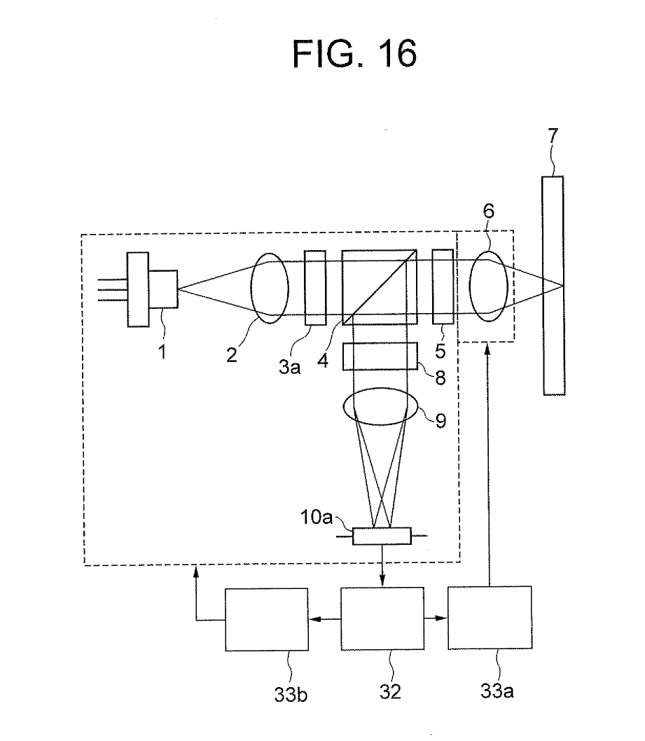

FIGS. 17A and 17B Plan views showing arrangements of focal spots on a disc in a traditional optical head device;

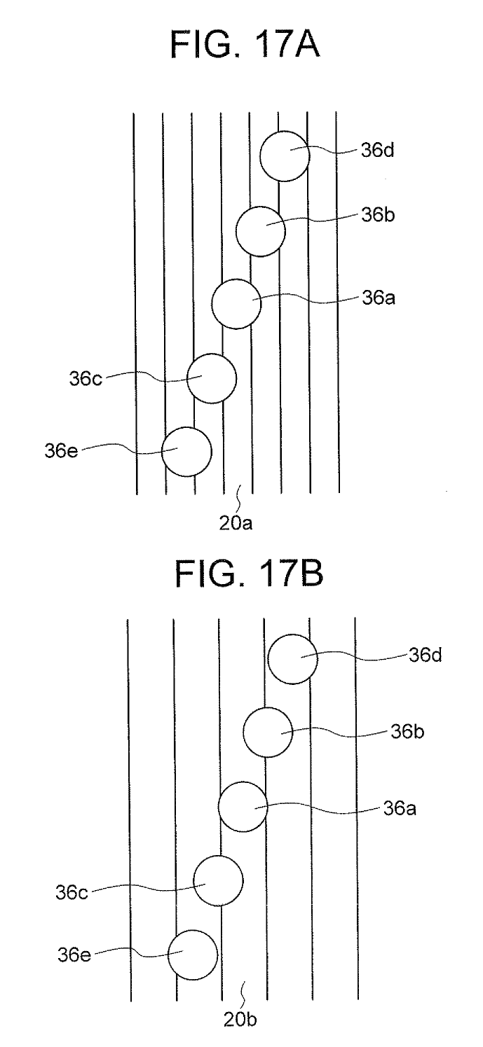

FIGS. 18A and 18B Plan views showing diffractive optical elements in a traditional optical head device;

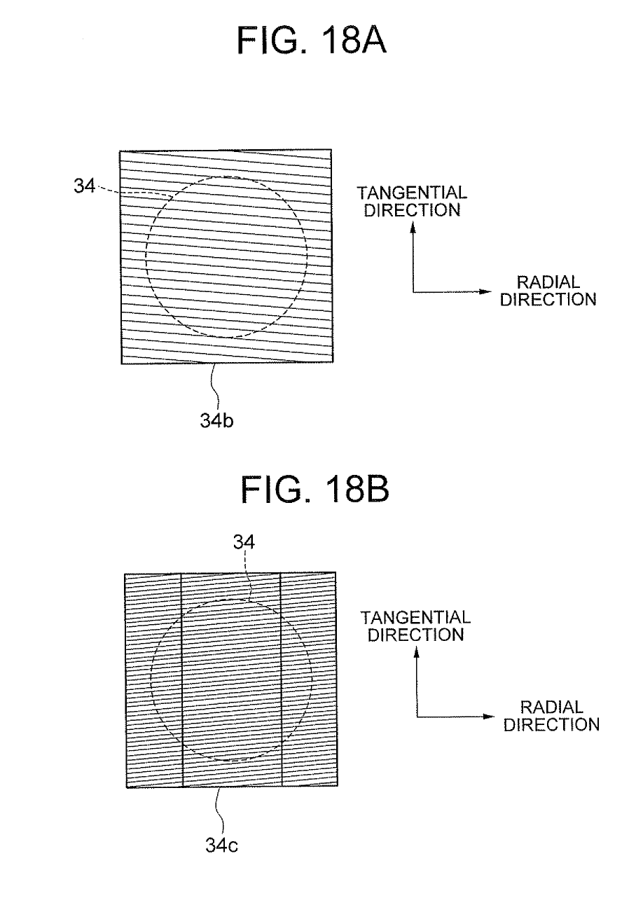

FIG. 19 A plan view showing a diffractive optical element in a traditional optical head device;

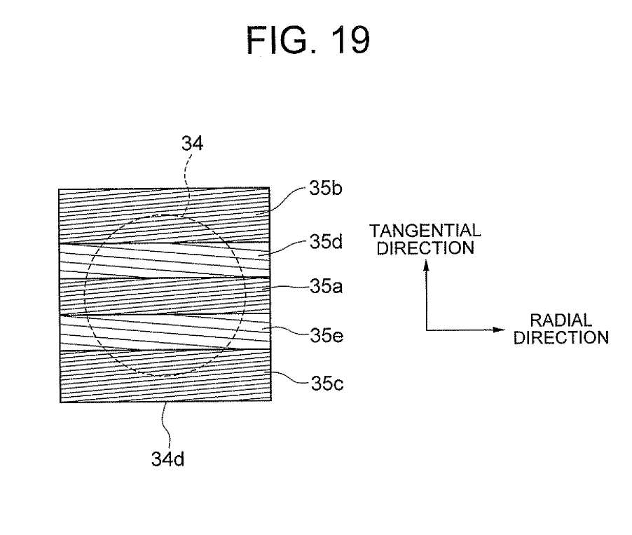

FIGS. 20A and 20B Plan views showing focal spots on a disc with the traditional optical head device;

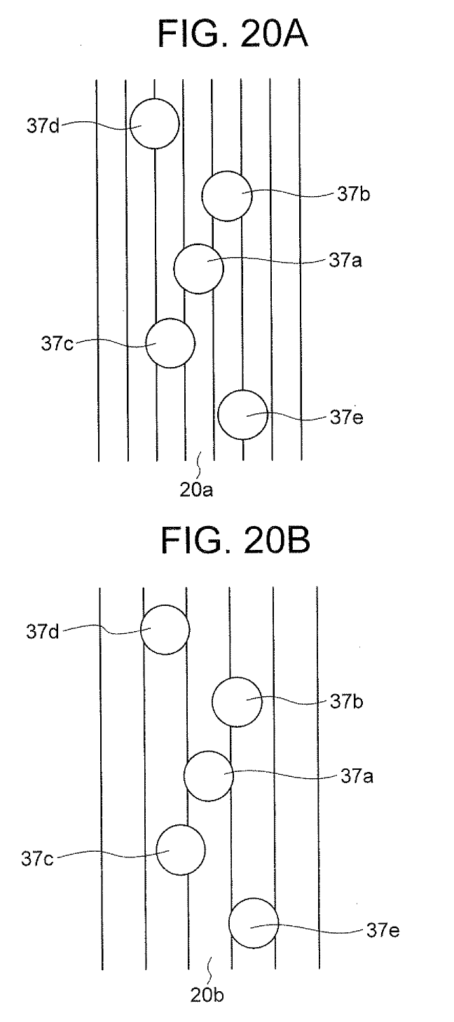

FIGS. 21A and 21B Plan views showing arrangements of focal spots on a disc with a traditional optical head device; and

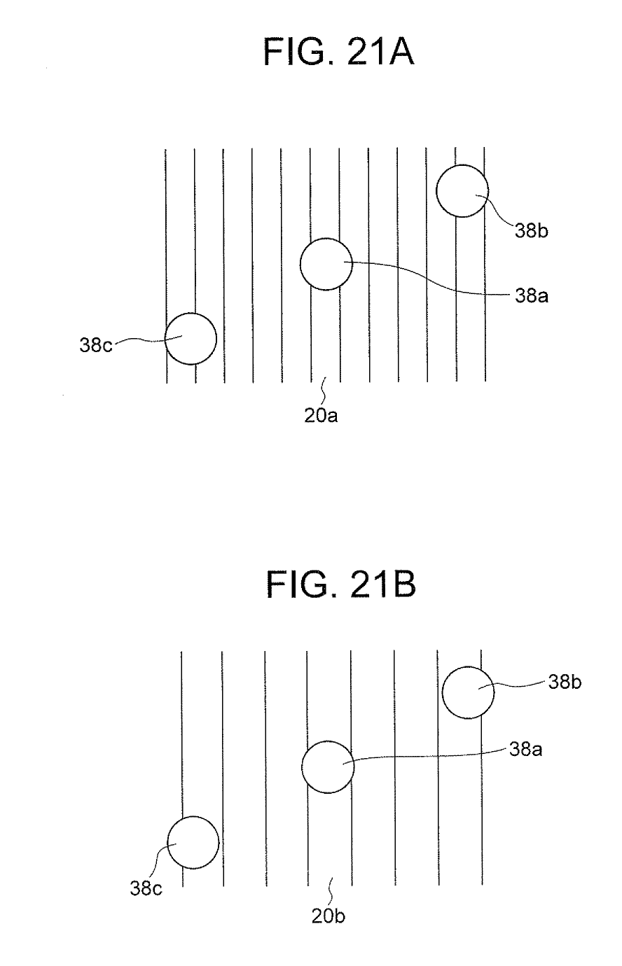

FIGS. 22A and 22B Plan views showing arrangements of focal spots on a disc with a traditional optical head device.

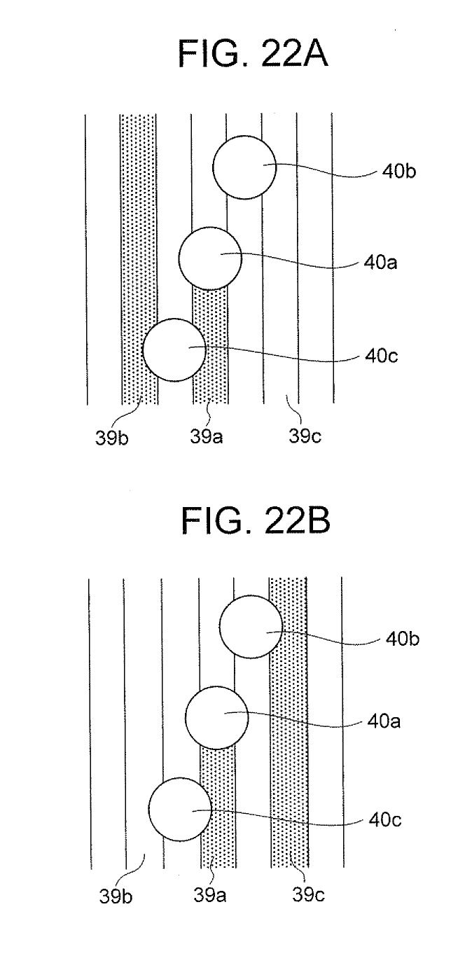

### DESCRIPTION OF THE CODES

1 SEMICONDUCTOR LASER (LIGHT SOURCE)
2 COLLIMATER LENS
3a, 3b DIFFRACTIVE OPTICAL ELEMENT
4 POLARIZATION BEAM SPLITTER
5 QUARTER WAVELENGTH PLATE
6 OBJECTIVE LENS
7 DISC (OPTICAL RECORDING MEDIUM)
8 CYLINDRICAL LENS
9 CONVEX LENS
10a, 10b PHOTODETECTOR
11a-11d DIFFRACTIVE OPTICAL ELEMENT
12a, 12b VARIABLE WAVELENGTH PLATE
13a-13i AREA
14a-14l AREA
15 SUBSTRATE
16 DIELECTRIC BODY
17a, 17b SUBSTRATE
18 LIQUID CRYSTAL POLYMER
19 FILLER
20a, 20b TRACK
21a-21e FOCAL SPOT
22a-22e FOCAL SPOT
23a-23l LIGHT RECEIVING SECTION
24a-24e OPTICAL SPOT
25a-25h LIGHT RECEIVING SECTION
26a-26c OPTICAL SPOT
27a-27g PUSH-PULL SIGNAL
28a-28f AREA
29a-29l AREA
30a-30i AREA
31a-31i AREA
32 CALCULATION CIRCUIT (CALCULATION UNIT)
33a, 33b DRIVE CIRCUIT
34a-34e DIFFRACTIVE OPTICAL ELEMENT
35a-35e AREA
36a-35e FOCAL SPOT
37a-37e FOCAL SPOT
38a-38c FOCAL SPOT
39a-39c TRACK
40a-40c FOCAL SPOT

1. An optical head device comprising: a light source; an objective lens for collecting an emitting light beam from the light source on an optical recording medium; a diffractive optical element provided in between the light source and the objective lens; and a photodetector for receiving a reflected light beam from the optical recording medium; and using a first optical recording medium having a first pitch of grooves composing a track and a second optical recording medium having a second pitch of grooves composing a track as the optical recording medium,
wherein
the diffractive optical element includes a function of generating a main beam, a first sub beam group, and a second sub beam group collected on a same track of the optical recording medium by the objective lens and having different phase distributions from each other, from an emitting light beam of the light source,
a light receiving section of the photodetector includes: a first light receiving section group for receiving a reflected light beam of the main beam reflected by the optical recording medium so as to detect a push-pull signal with respect to the first and second optical recording media; a second light receiving section group for receiving a reflected light beam of the first sub beam group reflected by the optical recording medium so as to detect a push-pull signal with respect to the first optical recording medium; and a third light receiving section group for receiving a reflected light beam of the second sub beam group reflected by the optical recording medium so as to detect a push-pull signal with respect to the second optical recording medium.

2. The optical head device, as claimed in claim 1, wherein
the diffractive optical element is formed on a surface vertical to an optical axis of an incoming light beam and has a diffraction grating which is divided into a plurality of areas by a line parallel to a direction corresponding to a tangential direction of the track,
the main beam is a zeroth order light beam transmitted by the diffraction grating, the first sub beam group is a first diffracted light beam group having an absolute value of a diffraction angle according to diffraction by the diffraction grating being a first value, and the second sub beam group is a second diffracted light beam group having an absolute value of a diffraction angle according to diffraction by the diffraction grating being a second value,
at least one area and another area in the plurality of areas have a function of shifting phases of the first diffracted light beam groups from each area by 180 degrees, and
at least one area and another area in the plurality of areas have a function of shifting phases of the second diffracted light beam groups from each area by 180 degrees.

3. An optical head device comprising: a light source; an objective lens for collecting an emitting light beam from the light source on an optical recording medium; a diffractive optical element provided in between the light source and the objective lens; and a photodetector for receiving a reflected light beam from the optical recording medium; and using a first optical recording medium having a first pitch of grooves composing a track and a second optical recording medium having a second pitch of grooves composing a track, as the optical recording medium,
wherein
the diffractive optical element includes a function of generating a main beam, a sub beam group which are collected on a same track of the optical recording medium by the objective lens and has different phase distributions from each other, from an emitting light beam of the light source,
a light receiving section of the photodetector includes a first light receiving section group for receiving a reflected light beam of the main beam reflected by the optical recording medium so as to detect a push-pull signal with respect to the first and the second optical recording media; and a second light receiving section group for receiving a reflected light beam of the sub beam group reflected by the optical recording medium so as to detect a push-pull signal with respect to the first and the second optical recording media,
the optical head device further comprises a phase distribution variation unit for varying phase distribution of the sub beam group into first phase distribution or second phase distribution, working with the diffractive optical element.

4. The optical head device, as claimed in claim 3, wherein
the diffractive optical element includes: a first diffraction grating formed on a first surface vertical to an optical axis of an incoming light beam and divided into a plurality of areas by a line parallel to a direction corresponding to a tangential direction of the track; and a second diffraction grating formed on a second surface vertical to an optical axis of an incoming light beam and has a different position in optical axis direction with respect to the first surface, and divided into a plurality of areas by a line parallel to a direction corresponding to a tangential direction of the track,
the main beam is a zeroth order light beam transmitted by the first and second diffraction gratings and the sub beam group is a diffracted light beam group diffracted by the first or second diffraction gratings, wherein the diffracted light beam group diffracted by the first diffraction grating has a first phase distribution and the diffracted light beam group diffracted by the second diffraction grating has a second phase distribution,
at least one area and another area in the plurality of areas of the first diffraction grating have a function of shifting phases of the diffracted light beam groups from each area by 180 degrees, and
at least one area and another area in the plurality of areas of the second diffraction grating have a function of shifting phases of the diffracted light beam groups from each area by 180 degrees.

5. The optical head device, as claimed in claim 3, wherein
the phase distribution variation unit is disposed in between the light source and the diffractive optical element and is a variable wavelength plate to vary or not to vary a polarization direction of an incoming light beam by 90 degrees,
the diffractive optical element includes a function of generating the sub beam group having the first or the second phase distribution in response to a polarization direction of an incoming light beam through the phase distribution variation unit.

6. An optical information recording or reproducing apparatus comprising:
the optical head device claimed in claim 1;
a first calculation unit for detecting a push-pull signal with respect to the first and second optical recording media according to an output signal of the first light receiving section group;
a second calculation unit for detecting a push-pull signal with respect to the first optical recording medium according to an output signal of the second light receiving section group;
a third calculation unit for detecting a push-pull signal with respect to the second optical recording medium according to an output signal of the third light receiving section group; and
a fourth calculation unit for detecting a tracking error signal from a difference between a push-pull signal detected from an output signal of the first light receiving section group and a push-pull signal detected from an output signal of the second light receiving section group when the optical recording medium is the first optical recording medium, and for detecting a tracking error signal from a difference between a push-pull signal detected from an output signal of the first light receiving section group and a push-pull signal detected from an output signal of the third light receiving section group when the optical recording medium is the second optical recording medium.

7. An optical information recording or reproducing apparatus comprising:
the optical head device claimed in claim 3;
a first calculation unit for detecting a push-pull signal with respect to the first and second optical recording media according to an output signal of the first light receiving section group;
a second calculation unit for detecting a push-pull signal with respect to the first and second optical recording media according to an output signal of the second light receiving section group;
a control unit for setting a phase distribution of the sub beam group to be the first phase distribution through the phase distribution variation unit when the optical recording medium is the first optical recording medium, and for setting a phase distribution of the sub beam group to be the second phase distribution through the phase distribution variation unit when the optical recording medium is the second optical recording medium; and
a third calculation unit for detecting a tracking error signal from a difference between a push-pull signal detected from an output signal of the first light receiving section group and a push-pull signal detected from an output signal of the second light receiving section group when the optical recording medium is the first optical recording medium, and for detecting a tracking error signal from a difference between a push-pull signal detected from an output signal of the first light receiving section group and a push-pull signal detected from an output signal of the second light receiving section group when the optical recording medium is the second optical recording medium.

8. An optical head device comprising: a light source; an objective lens for collecting an emitting light beam from the light source on an optical recording medium; a diffractive optical element provided in between the light source and the objective lens; and a photodetector for receiving a reflected light beam from the optical recording medium; and using a first optical recording medium having a first pitch of grooves composing a track and a second optical recording medium having a second pitch of grooves composing a track as the optical recording medium,
wherein
the diffractive optical element includes a function of generating a main beam, a first sub beam group, and a second sub beam group collected on a same track of the optical recording medium by the objective lens and having different phase distributions from each other, from an emitting light beam of the light source,
a light receiving section of the photodetector includes: a first light receiving means group for receiving a reflected light beam of the main beam reflected by the optical recording medium so as to detect a push-pull signal with respect to the first and second optical recording media; a second light receiving means group for receiving a reflected light beam of the first sub beam group reflected by the optical recording medium so as to detect a push-pull signal with respect to the first optical recording medium; and a third light receiving means group for receiving a reflected light beam of the second sub beam group reflected by the optical recording medium so as to detect a push-pull signal with respect to the second optical recording medium.

9. An optical head device comprising: a light source; an objective lens for collecting an emitting light beam from the light source on an optical recording medium; a diffractive optical element provided in between the light source and the objective lens; and a photodetector for receiving a reflected light beam from the optical recording medium; and using a first optical recording medium having a first pitch of grooves composing a track and a second optical recording medium having a second pitch of grooves composing a track, as the optical recording medium,
wherein
the diffractive optical element includes a function of generating a main beam, a sub beam group which are collected on a same track of the optical recording medium by the objective lens and has different phase distributions from each other, from an emitting light beam of the light source,
a light receiving section of the photodetector includes a first light receiving means group for receiving a reflected light beam of the main beam reflected by the optical recording medium so as to detect a push-pull signal with respect to the first and the second optical recording media; and a second light receiving means group for receiving a reflected light beam of the sub beam group reflected by the optical recording medium so as to detect a push-pull signal with respect to the first and the second optical recording media,
the optical head device further comprises a phase distribution variation means for varying phase distribution of the sub beam group into first phase distribution or second phase distribution, working with the diffractive optical element.

10. An optical information recording or reproducing apparatus comprising:
the optical head device claimed in claim 1;
a first calculation means for detecting a push-pull signal with respect to the first and second optical recording media according to an output signal of the first light receiving section group;
a second calculation means for detecting a push-pull signal with respect to the first optical recording medium according to an output signal of the second light receiving section group;
a third calculation means for detecting a push-pull signal with respect to the second optical recording medium according to an output signal of the third light receiving section group; and
a fourth calculation means for detecting a tracking error signal from a difference between a push-pull signal detected from an output signal of the first light receiving section group and a push-pull signal detected from an output signal of the second light receiving section group when the optical recording medium is the first optical recording medium, and for detecting a tracking error signal from a difference between a push-pull signal detected from an output signal of the first light receiving section group and a push-pull signal detected from an output signal of the third light receiving section group when the optical recording medium is the second optical recording medium.

11. An optical information recording or reproducing apparatus comprising:
the optical head device claimed in claim 4;
a first calculation means for detecting a push-pull signal with respect to the first and second optical recording media according to an output signal of the first light receiving section group;
a second calculation means for detecting a push-pull signal with respect to the first and second optical recording media according to an output signal of the second light receiving section group;
a control means for setting a phase distribution of the sub beam group to be the first phase distribution through the phase distribution variation unit when the optical recording medium is the first optical recording medium, and for setting a phase distribution of the sub beam group to be the second phase distribution through the phase distribution variation unit when the optical recording medium is the second optical recording medium; and
a third calculation means for detecting a tracking error signal from a difference between a push-pull signal detected from an output signal of the first light receiving section group and a push-pull signal detected from an output signal of the second light receiving section group when the optical recording medium is the first optical recording medium, and for detecting a tracking error signal from a difference between a push-pull signal detected from an output signal of the first light receiving section group and a push-pull signal detected from an output signal of the second light receiving section group when the optical recording medium is the second optical recording medium.
